(19) United States
(12) Patent Application Publication
(10) Pub. No.: US 2025/0320681 A1
(43) Pub. Date: Oct. 16, 2025

(54) GROUND PENETRATING RIG APPARATUS AND METHOD OF GROUND TREATMENT

(71) Applicant: Independence Materials Group, LLC, Virginia Beach, VA (US)

(72) Inventor: William A. GANTT, Blair, SC (US)

(73) Assignee: Independence Materials Group, LLC, Virginia Beach, VA (US)

(21) Appl. No.: 19/171,535

(22) Filed: Apr. 7, 2025

Related U.S. Application Data
(60) Provisional application No. 63/632,280, filed on Apr. 10, 2024.

(51) Int. Cl. E02D 3/12; A01C 23/02; A01G 25/09; A01M 17/00; E02B 11/00; E02D 7/24

(52) U.S. Cl. CPC E02D 3/126; A01C 23/026; A01G 25/09; A01M 17/002; E02B 11/00; E02D 7/24

(57) ABSTRACT

A ground penetrating rig that can be coupled to machinery (e.g., a skid steer, or the like). The ground penetrating rig may have one or more mast assemblies, each having one or more rods. The mast assemblies may be located in parallel and/or in series with each other. Each of the rods of the mast assemblies may be moveable in unison or independently. However, in some embodiments the rods may be moveable in unison until at least one rod is impeded by an obstruction, and as such, the movement of an impeded rod may be restricted while allowing continued movement other rods. One or more of the mast assemblies may be able to be adjusted in order to reduce the envelope of the rig for improved transportation. Multiple ground penetrating rigs may be operatively coupled to the machinery (e.g., front and rear) to improve ground treatment efficiency.

### CROSS REFERENCE AND PRIORITY CLAIM UNDER 35 U.S.C. § 119

This application claims priority to U.S. Provisional Application No. 63/632,280 entitled “Ground Penetrating Rig Apparatus and Method of Ground Treatment” filed on Apr. 10, 2024, which is assigned to the assignee hereof and the entirety of which is incorporated by reference herein.

### FIELD

This application relates to a ground penetrating rig, and more particularly, to a ground penetrating rig that is used to deliver material into the ground for ground treatment.

### BACKGROUND

Ground penetrating rig designs are bulky and difficult to transport, can be prone to damage during use, and/or can be inefficient. There is a need for improved ground penetrating rigs that are more efficient in penetrating the ground and providing soil treatment.

### SUMMARY

A ground penetrating rig that can be operatively coupled to machinery (e.g., a skid steer, or the like). In some embodiments, multiple ground penetrating rigs may be operatively coupled to the machinery (e.g., front, rear, sides, or the like. The ground penetrating rig may comprise of one or more mast assemblies, each having one or more rods. The mast assemblies may be located in parallel and/or in series with each other. Each of the rods of the mast assemblies may be moveable in unison or independently. However, in some embodiments the rods may be moveable in unison until at least one rod is impeded by an obstruction, and as such, the movement of an impeded rod may be restricted while allowing continued movement of one or more other rods. In some embodiments, the rods may be rotatable using a drill drive to aid in inserting the rods into the ground. The ability for the movement of an impeded rod to be restricted while other rods may continue to be moved further into the ground reduces the potential damage to the impeded rod. Furthermore, one or more of the mast assemblies may be able to be adjusted for transportation. For example, one or more mast assemblies may be able to be folded, swung, removed, slid, or the like with respect to other mast assemblies within the rig in order to reduce the envelope of the rig. As such, the rig may be more easily transported for use on different sites.

One embodiment of the invention is a ground penetrating rig apparatus for treating the ground. The apparatus comprises one or more mast assemblies and one or more support drive assemblies operatively coupled to the one or more mast assemblies. A mast assembly comprises one or more mast members, one or more rod supports operatively coupled to the one or more mast members, and a rod operatively coupled to the one or more rod supports. The one or more support drive assemblies are configured to extend the rod of the one or more mast assemblies into the ground and retract the rod from the ground.

In other embodiments, the one or more rod supports comprise one or more dynamic rod supports. The one or more support drive assemblies are configured to move the one or more dynamic rod supports to extend the rod into the ground and retract the rod from the ground.

In still other embodiments, the one or more dynamic rod supports comprise an upper dynamic rod support operatively coupled to a proximal end of the rod, and one or more intermediate dynamic rod supports. The upper dynamic rod support moves with the rod, and the one or more intermediate dynamic rod supports move with the rod and allow the rod to move with respect to the one or more intermediate dynamic rod supports.

In yet other embodiments, the one or more rod supports comprise a static rod support adjacent a distal end of the mast assembly. The static rod support allows the rod to move with respect to the static rod support and guides the rod into the ground.

In other embodiments, the one or more support drive assemblies comprise a drive, a drive train, one or more flexible members, and one or more detachable connectors. The one or more detachable connectors are configured to detach to stop the movement of the one or more dynamic rod supports. Furthermore, the one or more detachable connectors are configured to engage to move the one or more dynamic rod supports.

In further accord with embodiments, the drive is a hydraulic drive, and the one or more flexible members comprise one or more chains.

In other embodiments, the apparatus comprises one or more rod drive assemblies that are operatively coupled to the one or more mast assemblies. The one or more rod drive assemblies are configured to rotate the rod to aid in extending the rod into the ground.

In still other embodiments, the one or more mast assemblies comprise two or more mast assemblies, and a rig support assembly operatively coupling the two or more mast assemblies. The one or more support drive assemblies are configured to restrict movement of a first rod of a first mast assembly when the first rod is impeded by an obstruction while continuing to allow a second rod of a second mast assembly to be extended into the ground.

In yet other embodiments, the one or more support drive assemblies comprise one or more hydraulic drives that are disengaged through a bypass when the first rod is impeded.

In other embodiments, the one or more mast assemblies comprise four or more mast assemblies, and a rig support assembly comprising an adjustment assembly. The rig support assembly operatively couples the four or more mast assemblies. The adjustment assembly is configured to allow adjustment of at least one of the four or more mast assemblies into to a transport configuration that reduces the envelope of the rig apparatus or to adjust the distance between the rods.

In further accord with embodiments, the one or more mast assemblies comprise two or more mast assemblies, and a rig support assembly operatively coupling the two or more mast assemblies in a transverse configuration.

In other embodiments, the one or more mast assemblies comprise two or more mast assemblies, and a rig support assembly operatively coupling the two or more mast assemblies in a longitudinal configuration.

In still other embodiments, the apparatus further comprises a fluid supply system. The rod is operatively coupled to the fluid supply system configured to supply fluid to the rod and into the ground for ground treatment.

In yet other embodiments, the fluid supply system comprises a supply hose operatively coupled on one end to the rod, a hose support for supporting the supply hose, and a fluid supply operatively coupled to an opposite end of the supply hose and configured to supply the fluid to the rod for the ground treatment. The fluid supply system provides the fluid to the rod for the ground treatment, and the hose support allows for extension of the hose as the rod is extended into the ground and retraction as the rod is removed from the ground.

In other embodiments, the apparatus further comprises a rig support assembly configured for operative coupling with moveable machinery having a hydraulic system. The support drive assembly is powered by the hydraulic system of the moveable machinery.

Another embodiment of the invention comprises a ground penetrating equipment apparatus for treating the ground. The apparatus comprises moveable machinery having a hydraulic system, and one or more ground penetrating rigs operatively coupled to the moveable machinery. A ground penetrating rig comprises one or more mast assemblies and one or more support drive assemblies. The one or more mast assemblies comprise one or more mast members, one or more rod supports operatively coupled to the one or more mast members, and a rod operatively coupled to the one or more rod supports. The one or more support drive assemblies are operatively coupled to the one or more mast assemblies and to the hydraulic system of the moveable machinery to extend the rod into the ground and retract the rod from the ground.

In further accord with embodiments, the one or more mast assemblies of the ground penetrating rig comprises two or more mast assemblies, and a rig support assembly operatively coupling the two or more mast assemblies. The one or more support drive assemblies are configured to restrict movement of a first rod of a first mast assembly when the first rod is impeded by an obstruction while continuing to allow a second rod of a second mast assembly to be extended into the ground.

In other embodiments, the one or more ground penetrating rigs comprise a first ground penetrating rig operatively coupled to a front of the moveable machinery, and a second ground penetrating rig operatively coupled to a rear of the moveable machinery.

Another embodiment of the invention comprises a method of treating the ground using a ground penetrating equipment apparatus. The ground penetrating equipment apparatus comprises moveable machinery comprising a hydraulic system and one or more ground penetrating rigs operatively coupled to the moveable machinery. A ground penetrating rig comprises one or more mast assemblies and one or more support drive assemblies. A mast assembly comprises one or more mast members, one or more rod supports operatively coupled to the one or more mast members, and a rod operatively coupled to the one or more rod supports. The one or more support drive assemblies are operatively coupled to the one or more mast assemblies and to the hydraulic system of the moveable machinery. The method comprises extending the rod of the one or more mast assemblies into the ground, and treating the ground with fluid through the rod of the one or more mast assemblies.

In further accord with embodiments, the one or more mast assemblies comprise two or more mast assemblies and a rig support assembly operatively coupling the two or more mast assemblies. The method further comprises restricting movement of a first rod of a first mast assembly when the first rod is impeded by an obstruction, and continuing to allow a second rod of a second mast assembly to be extended into the ground while the movement of the first rod of the first mast assembly is restricted.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate embodiments of the invention, and which are not necessarily drawn to scale, wherein:

FIG. 1A illustrates a rear perspective view of machinery with a ground penetrating rig having multiple mast assemblies with one or more rods in parallel, in accordance with some embodiments of the disclosure.

FIG. 1B illustrates a front perspective view of machinery with a ground penetrating rig having multiple mast assemblies with one or more rods in parallel, in accordance with some embodiments of the disclosure.

FIG. 1C illustrates a rear perspective view of machinery with ground penetrating rigs having multiple mast assemblies located on both ends of the machinery, in accordance with some embodiments of the disclosure.

FIG. 1D illustrates a front perspective view of machinery with ground penetrating rigs having multiple mast assemblies located on both ends of the machinery, in accordance with some embodiments of the disclosure.

FIG. 2A illustrates a perspective front view of a single mast assembly for a ground penetrating rig, in accordance with some embodiments of the disclosure.

FIG. 2B illustrates a perspective rear view of a single mast assembly for a ground penetrating rig, in accordance with some embodiments of the disclosure.

FIG. 2C illustrates a perspective exploded view of a single mast assembly for a ground penetrating rig, in accordance with some embodiments of the disclosure.

FIG. 2D illustrates a side view of a single mast assembly for a ground penetrating rig, in accordance with some embodiments of the disclosure.

FIG. 2E illustrates a front view of a single mast assembly for a ground penetrating rig, in accordance with some embodiments of the disclosure.

FIG. 2F illustrates a rear view of a single mast assembly for a ground penetrating rig, in accordance with some embodiments of the disclosure.

FIG. 2G illustrates a perspective front view of a single mast assembly for a ground penetrating rig, in accordance with some embodiments of the disclosure.

FIG. 2H illustrates a perspective front view of an upper portion of a mast assembly for a ground penetrating rig, in accordance with some embodiments of the disclosure.

FIG. 2I illustrates a perspective rear view of an upper portion of a mast assembly for a ground penetrating rig, in accordance with some embodiments of the disclosure.

FIG. 2J illustrates a perspective front view of an intermediate portion of a mast assembly for a ground penetrating rig, in accordance with some embodiments of the disclosure.

FIG. 2K illustrates a perspective rear view of an intermediate portion of a mast assembly for a ground penetrating rig, in accordance with some embodiments of the disclosure.

FIG. 2L illustrates a perspective front view of a lower portion of a mast assembly for a ground penetrating rig, in accordance with some embodiments of the disclosure.

FIG. 2M illustrates a perspective rear view of a lower portion of a mast assembly for a ground penetrating rig, in accordance with some embodiments of the disclosure.

FIG. 2N illustrates a perspective view of a rod support with the rod removed, in accordance with embodiments of the disclosure.

FIG. 3A illustrates a perspective front view of a ground penetrating rig having multiple mast assemblies, in accordance with some embodiments of the disclosure.

FIG. 3B illustrates a perspective rear view of a ground penetrating rig having multiple mast assemblies, in accordance with some embodiments of the disclosure.

FIG. 4A illustrates a perspective front view of an upper portion of a ground penetrating rig having multiple mast assemblies, in accordance with some embodiments of the disclosure.

FIG. 4B illustrates a perspective rear view of an upper portion of a ground penetrating rig having multiple mast assemblies, in accordance with some embodiments of the disclosure.

FIG. 5A illustrates a perspective front view of an intermediate portion of a ground penetrating rig having multiple mast assemblies, in accordance with some embodiments of the disclosure.

FIG. 5B illustrates a perspective rear view of an intermediate portion of a ground penetrating rig having multiple mast assemblies, in accordance with some embodiments of the disclosure.

FIG. 6A illustrates a perspective front view of a lower portion of a ground penetrating rig having multiple mast assemblies, in accordance with some embodiments of the disclosure.

FIG. 6B illustrates a perspective rear view of a lower portion of a ground penetrating rig having multiple mast assemblies, in accordance with some embodiments of the disclosure.

FIG. 6C illustrates a perspective view rear view of a fluid supply assembly and/or a rod drive assembly, in accordance with some embodiments of the disclosure.

FIG. 6D illustrates a perspective enlarged view front view of a fluid supply assembly and/or a rod drive assembly, in accordance with some embodiments of the disclosure.

FIG. 6E illustrates a perspective view of a rod cover, in accordance with embodiments of the disclosure.

FIG. 7A illustrates a perspective front view of a single rod of ground penetrating rig before the rod is inserted into the ground, in accordance with some embodiments of the disclosure.

FIG. 7B illustrates a perspective front view of a single rod of ground penetrating rig with the rod inserted into the ground through the movement of the rod supports, in accordance with some embodiments of the disclosure.

FIG. 7C illustrates a perspective front view of a single rod of ground penetrating rig with the rod inserted into the ground through the movement of the rod supports, in accordance with some embodiments of the disclosure.

FIG. 8A illustrates a perspective side cross-sectional view of the upper dynamic rod support of a mast assembly, in accordance with some embodiments of the disclosure.

FIG. 8B illustrates a perspective top cross-sectional view of the first intermediate dynamic rod support of a mast assembly, in accordance with some embodiments of the disclosure.

FIG. 8C illustrates a perspective bottom cross-sectional view of the first intermediate dynamic rod support of a mast assembly, in accordance with some embodiments of the disclosure.

FIG. 8D illustrates a perspective top cross-sectional view of the second intermediate dynamic rod support of a mast assembly, in accordance with some embodiments of the disclosure.

FIG. 8E illustrates a perspective bottom cross-sectional view of the second intermediate dynamic rod support of a mast assembly, in accordance with some embodiments of the disclosure.

FIG. 8F illustrates a perspective top view of the lower static rod support of a mast assembly, in accordance with some embodiments of the disclosure.

FIG. 9 illustrates a process flow for the operation of the ground penetrating rig, in accordance with some embodiments of the disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

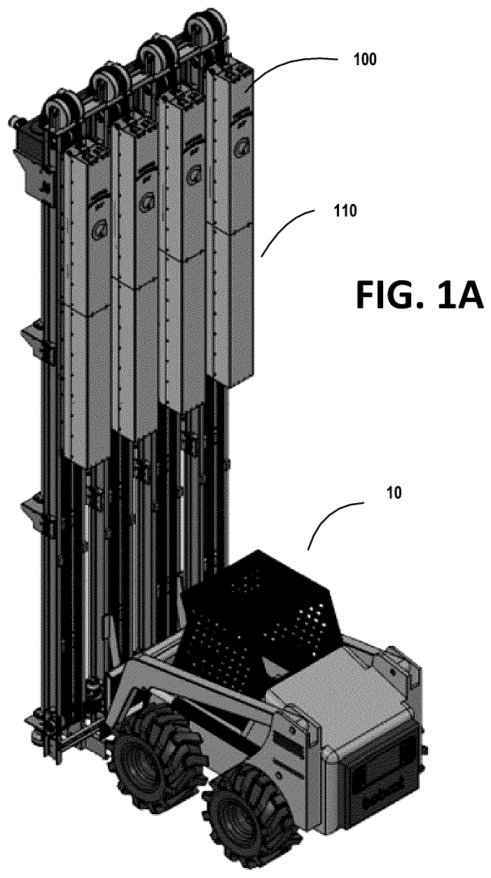

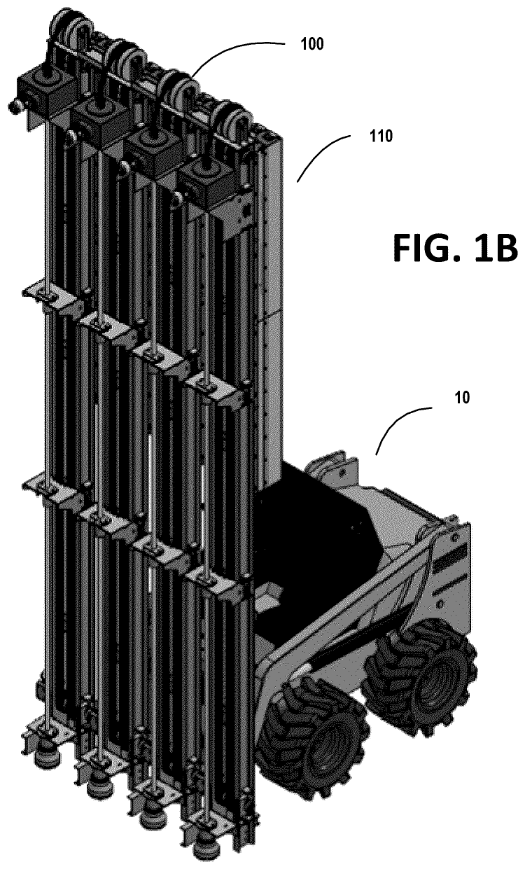

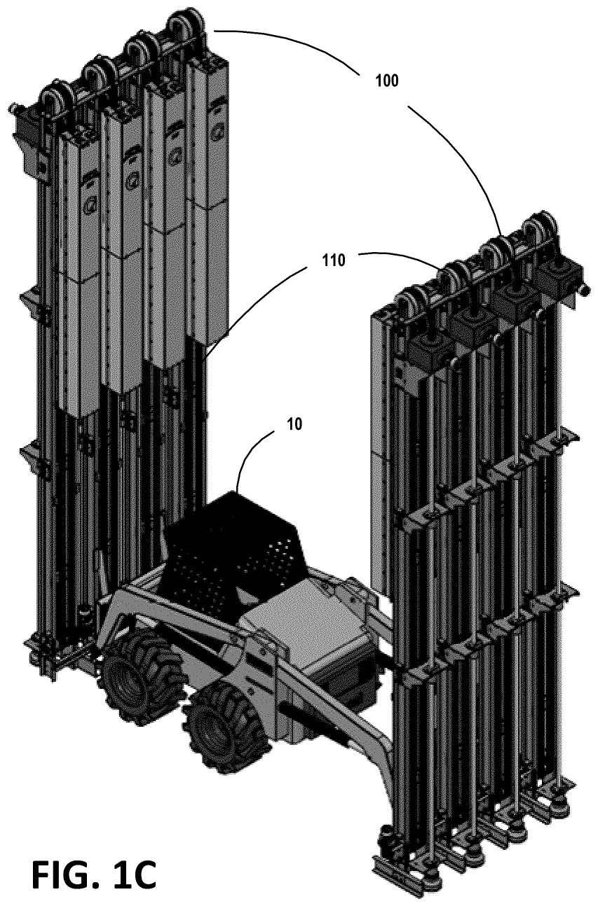

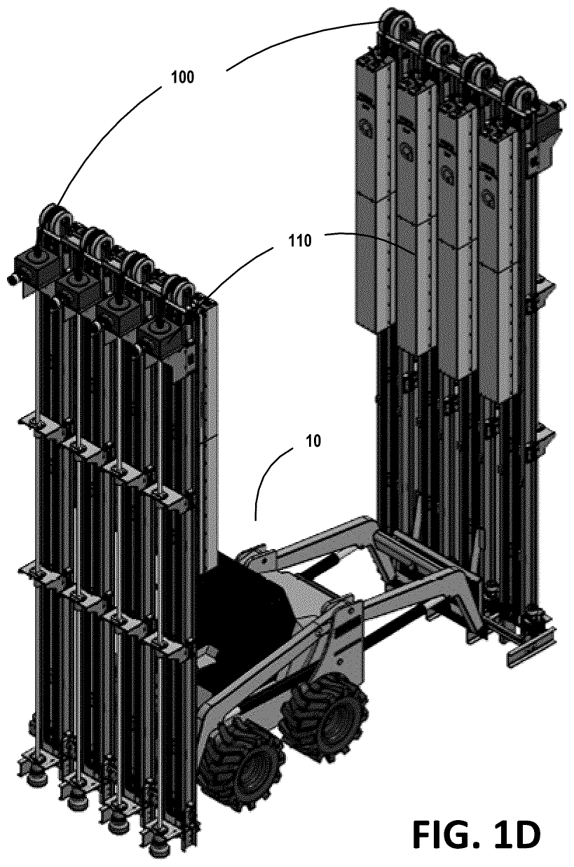

FIGS. 1A through 1D illustrate embodiments of the invention in which a ground penetrating rig 100 is operatively coupled to moving machinery 10, in particular a skid steer 12. While a particular type of skid steer 12 is illustrated, it should be understood that the skid steer 12 may be any type of skid steer 12 having different configurations, including different wheels, tracks, other transport devices, and/or mechanical and/or actuation devices (e.g., hydraulics, pneumatics, or the like) that allow the skid steer 12 to move different types of attachments that may be operatively coupled to the skid steer 12. While the moving machinery 10 is illustrated as being a skid steer 12, it should be understood that the moving machinery 10 may be any type of machinery, such as a back-hoe, digger, bulldozer, or the like.

As will be described in further detail herein, the ground penetrating rig 100 (otherwise described as a ground penetrating rig apparatus, a penetrating rig, a rig, or the like) may comprise of one or more mast assemblies 110 (otherwise described as a mast, or the like), each having a rod 120; however, in some embodiments a mast assembly 110 may have multiple rods 120. In the illustrated embodiments, the ground penetrating rig 100 has four mast assemblies 110 located in parallel with each other (e.g., transversely across the width of the machinery 10), each having a single rod 120. Additionally, or alternatively, the ground penetrating rig 100 may have mast assemblies 110 in series with each other (e.g., two or more mast assemblies 110 extending longitudinally, such as away from the machinery 10). For example, returning to FIGS. 1A and 1B, in some embodiments, a penetrating rig 100 may be operatively coupled to the front (or rear) of the moving machinery 10 having one or more mast assemblies 110 in parallel with each other. Additionally, or alternatively, not specifically illustrated in the figures, the ground penetrating rig 100 may have two or more mast assemblies 110 located in series with each other. In some embodiment, the mast assemblies 110 may be located in parallel with each other and/or in series with each other, and moreover, may be located in the same plane or may be offset with each other (e.g., multiple rows or columns may be in the same plane or may be offset). As illustrated in FIGS. 1C and 1D, a rig 100 may be operatively coupled to both ends of the movable machinery 10, and each rig 10 may have one or more mast assemblies 110 that extend transversely across at least a portion of the width and/or longitudinally away from the movable machinery 10. In this way, the moveable machinery 10 may increase the area per time over which the ground treatment may be applied, as will be described in further detail herein.

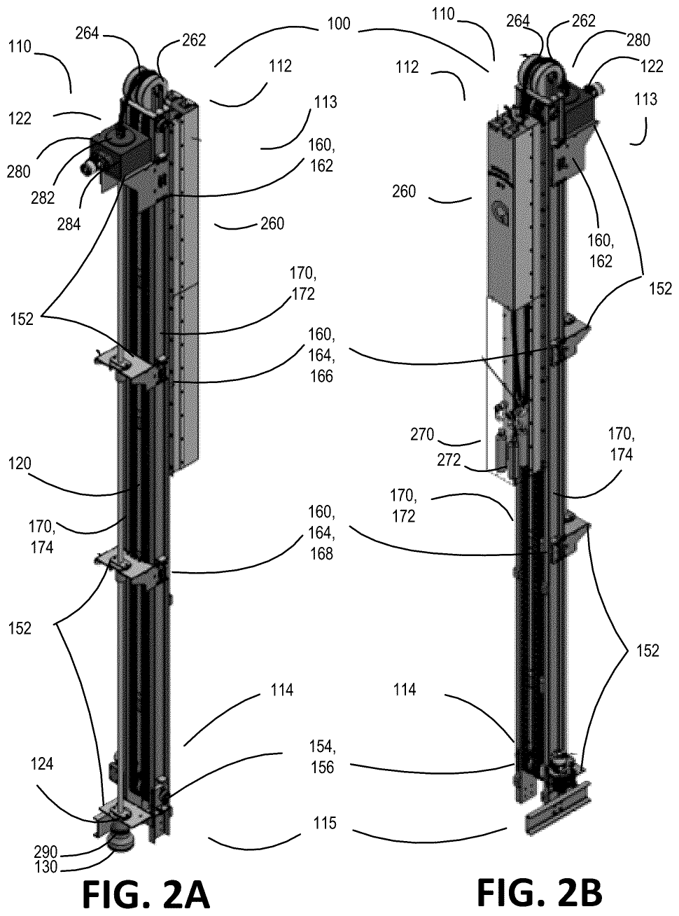

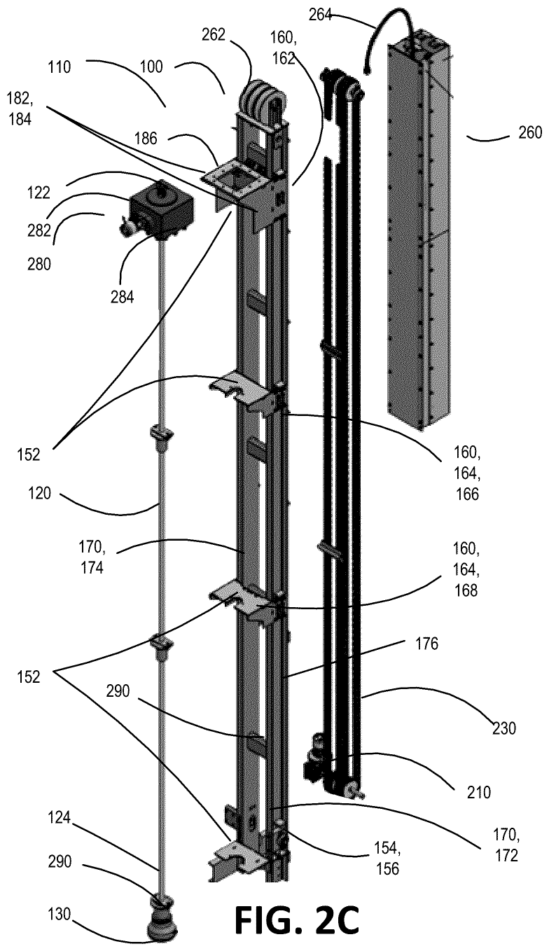

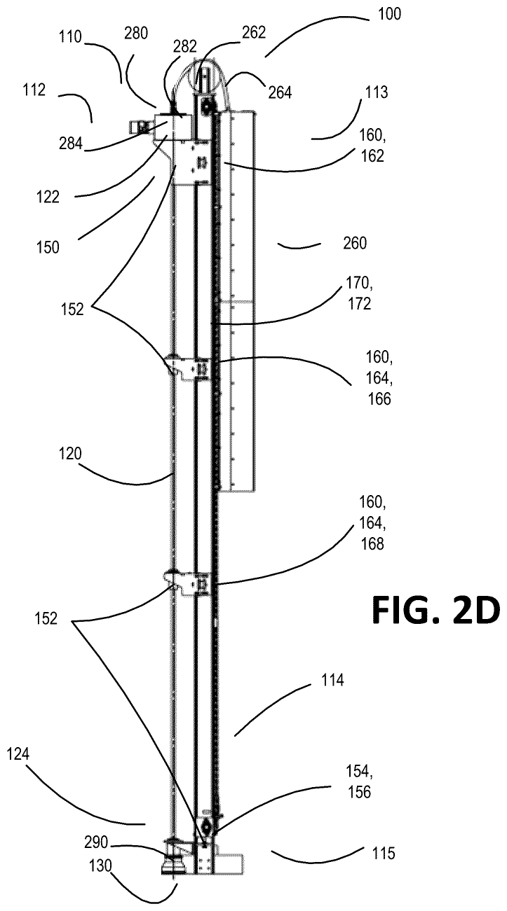

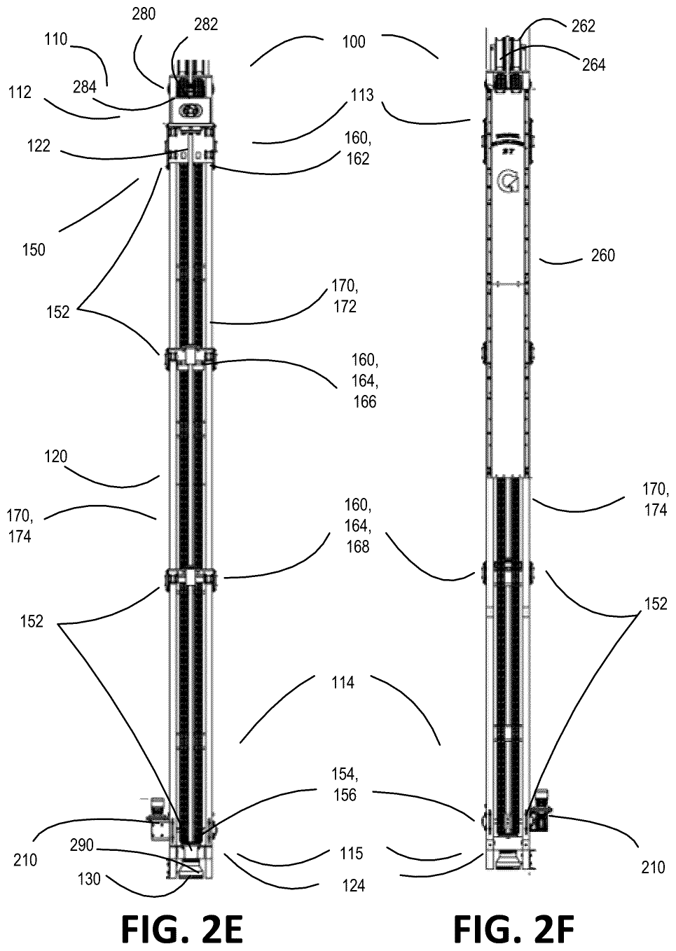

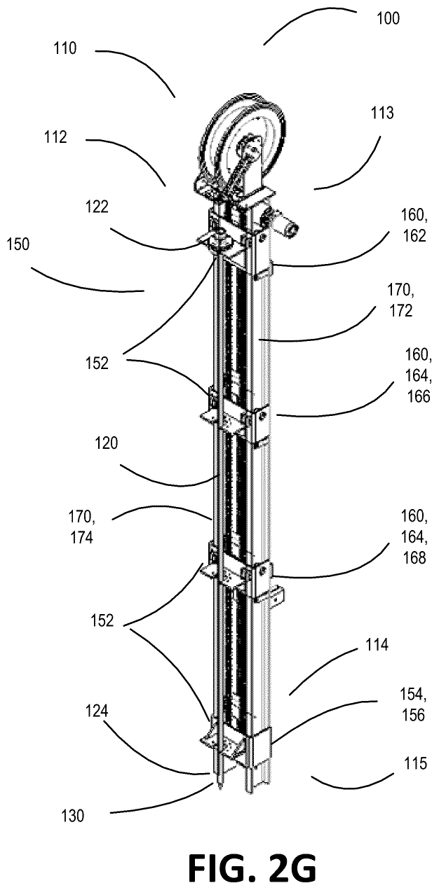

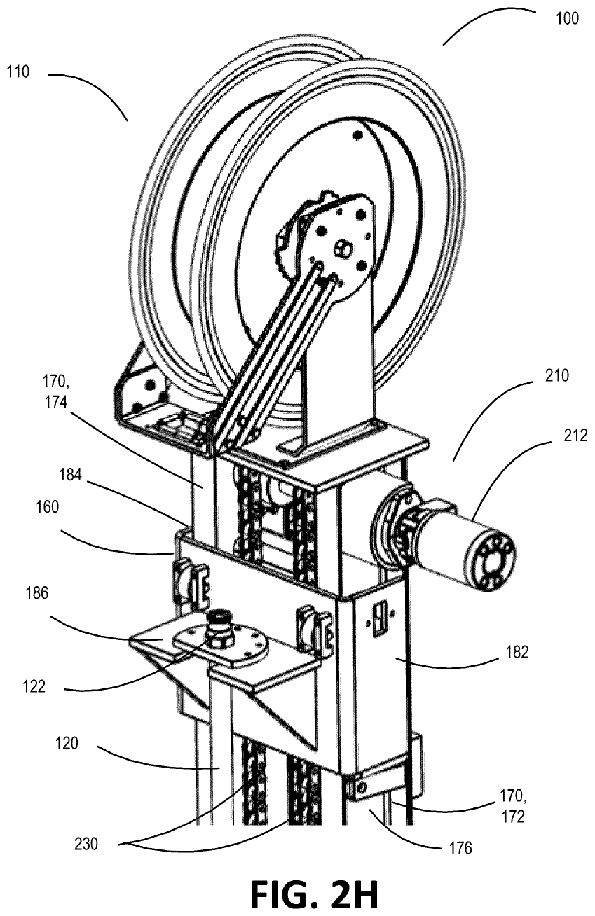

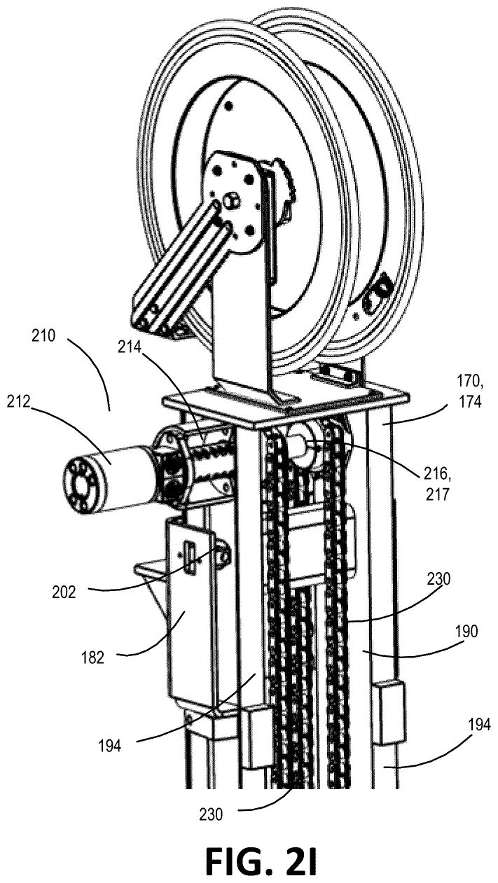

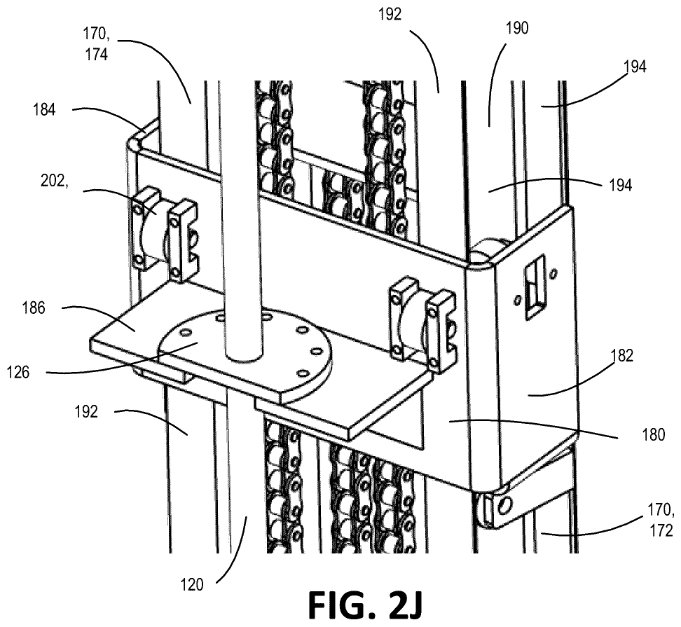

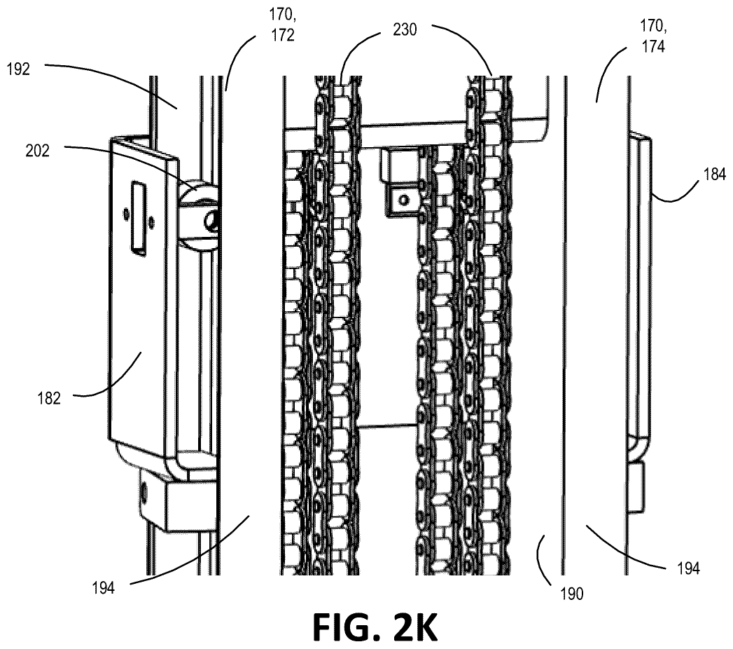

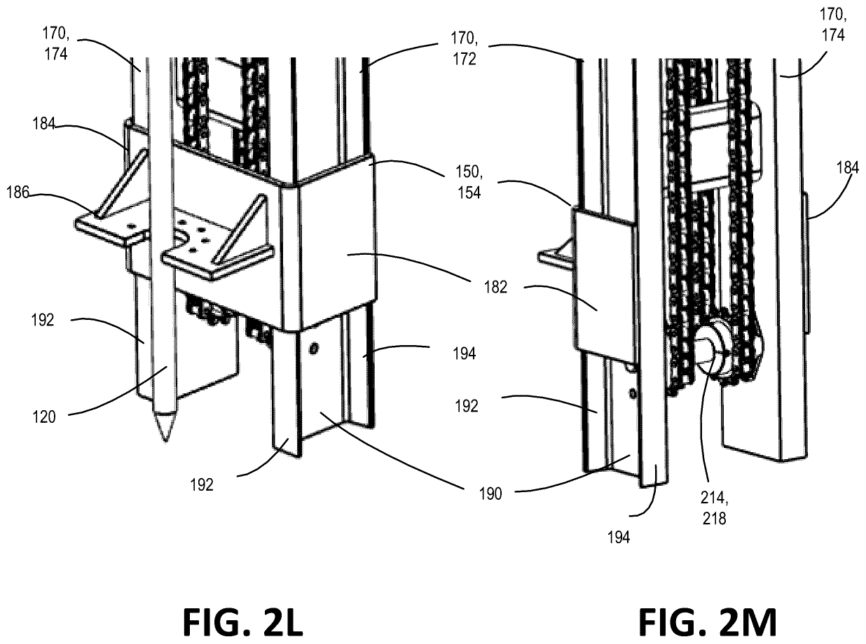

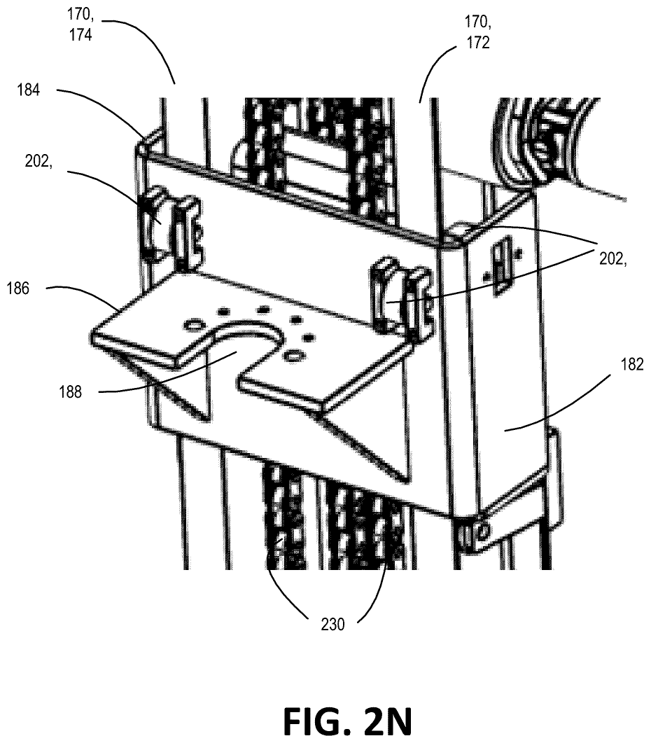

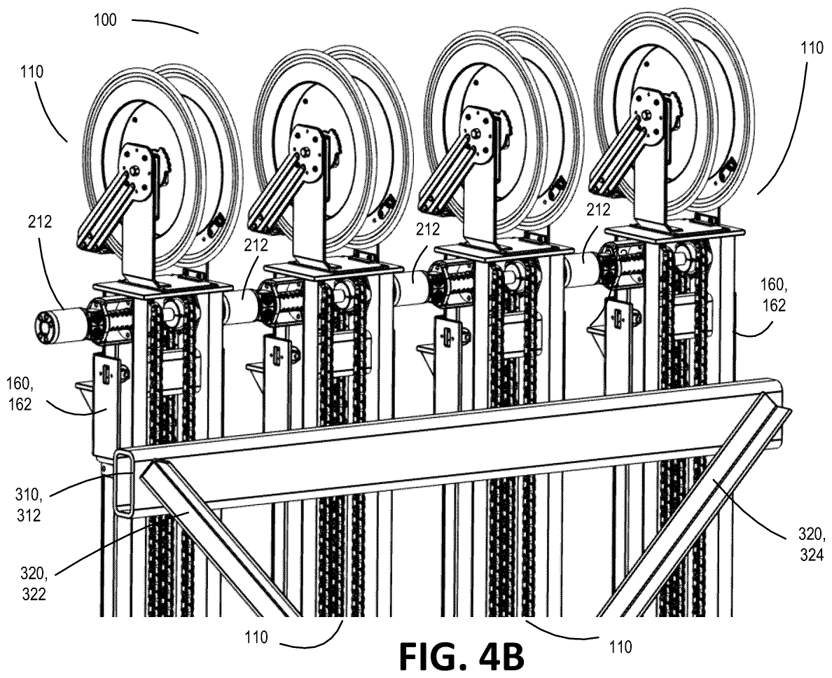

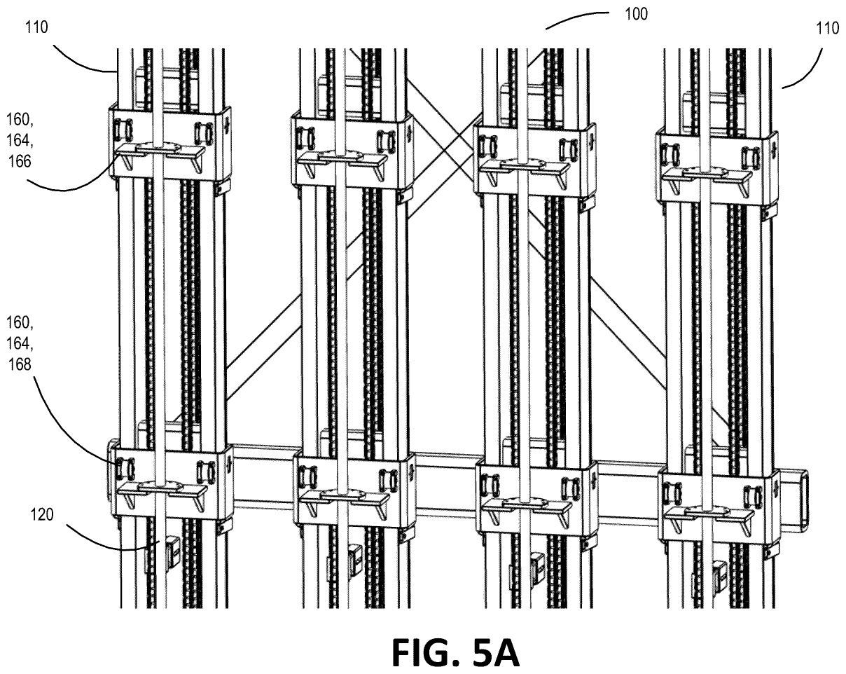

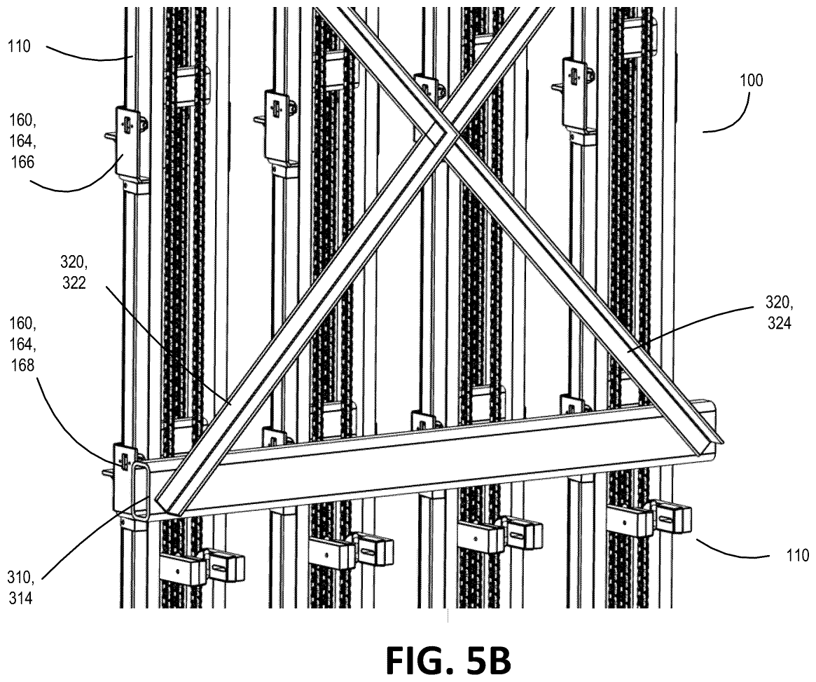

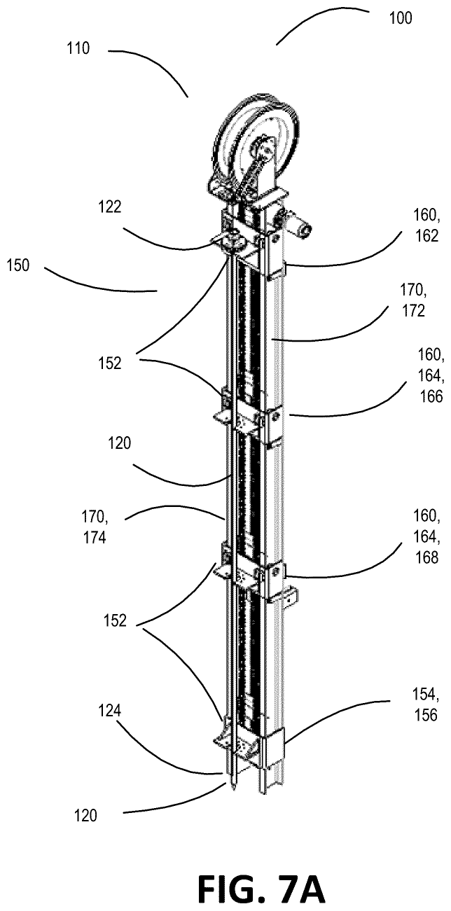

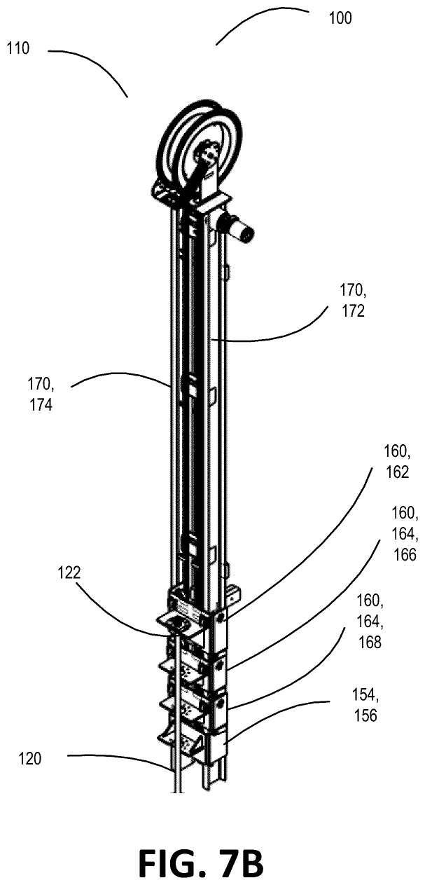

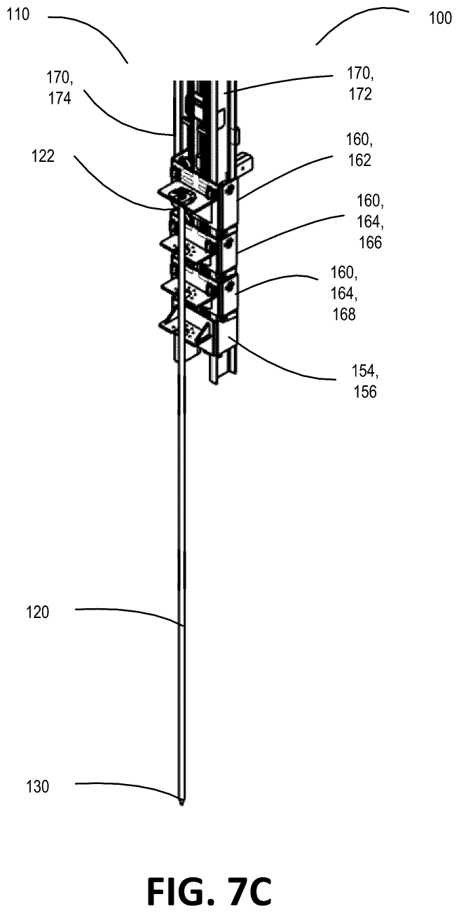

FIGS. 2A through 6B illustrate embodiments of the ground penetrating rig 100 having one or more mast assemblies 110. The one or more mast assemblies 110 may have an upper mast portion 112 having a proximal mast end 113, and a lower mast portion 114 have a distal mast end 115. As illustrated in FIGS. 2A through 2N, the mast assembly 110 may comprise a rod 120 having a proximal rod end 122, a distal rod end 124, and a nozzle 130. The rod 120 may be operatively coupled to rod support assemblies 150. The rod support assemblies may comprise of one or more rod supports 152, which comprise one or more static rod supports 154 and one or more dynamic rod supports 160 (otherwise described as rod carriages). As illustrated, in FIGS. 2A-C and 2G, the one or more static rod supports 154 may comprise a lower static rod support 156, while the one or dynamic rod supports 160 may comprise an upper dynamic rod support 162 (otherwise described as the drill drive carriage) and one or more intermediate dynamic rod supports 164 (otherwise described as pass through carriages), such as a first intermediate dynamic rod support 166 (otherwise described as an upper pass through carriage) and a second intermediate dynamic rod support 168 (otherwise described as a lower pass through carriage). The movement of the rod 120 through the use of the one or more dynamic rod supports 160 will be described in further detail later with respect to FIGS. 7A through 7B.

As further illustrated in FIGS. 2A through 2N, the one or more rod supports 152 may be operatively coupled to one or more mast members 170 that may form a mast frame, such as a first mast member 172 and a second mast member 174. The one or more mast members 170 may be structured to form a mast channel 176. For example, the one or more mast members 170 may be c-shaped, u-shaped, I-shaped, H-shaped, L-shaped, s-shaped, z-shaped, J-shaped, T-shaped, v-shaped, or other like shape. The one or more mast members 170 may comprise a mast member web 190, a first mast member flange 192 operatively coupled to the mast member web 190, and a second mast member flange 194 operatively coupled to the mast member web 190. The mast member web 190, the first mast member flange 192, and the second mast member flange 194 may form the mast channel 176. It should be understood, that while the mast members 170 may be illustrated a c-shaped members, the mast members 170 may be any type of shape.

The one or more static rod supports 154, such as the lower static rod support 156, may be operatively coupled to the one or more mast members 170, such as operatively coupling the first mast member 172 to the second mast member 174, through the use of connectors (e.g., through welds, fasteners—bolts, nuts, screws, rivets, pins, or other fasteners, clips, clamps, or other types of connectors). Additionally, or alternatively, one or more other mast members supports may operatively couple the first mast member 172 and the second mast member 174 together, in a similar way. The one or more dynamic rod supports 160 may be operatively coupled to, and moveable with respect to, the one or more mast members 170. The one or more static rod supports 154 and/or the one or more dynamic rod supports 160 may have any shape, such as any shape that is the same as or similar to the mast members 170. In the illustrated embodiments, the one or more mast members 170 may be c-shaped, while the one or more dynamic supports 160 may also be c-shaped and extend around at least a portion of the one or more mast members 170 (e.g., around the first mast member 172 and the second mast member 174). As such, the one or more dynamic supports 160 may have a rod support web 180, a first rod support flange 182 operatively coupled to the rod support web 180, and a second rod support flange 184 operatively coupled to the rod support web 180.

Regardless of the shape of the one or more dynamic rod supports 160 and/or the one or more mast members 170, the one or more dynamic rod supports 160 may move with respect to the one or more mast members 170. In some embodiment, the one or more dynamic rod supports 160 may be made of a material to reduce friction (e.g., nylon, polytetrafluoroethylene (PTFE), or the like), have a friction reducing material located thereon, may utilize wheels, tracks, rack and pinions, and/or other like moveable components that aid in allowing the movement of the one or more dynamic rod supports 160 with respect to the one or more mast members 170. In some embodiments, one or more wheel assemblies 202 (e.g., having a wheel, an axial, bearings, or the like) may be operatively coupled to the dynamic rod supports 160, such as to the rod support web 180, the first rod support flange 182, and/or the second rod support flange 184. As such, the one or more wheel assemblies 202 may engage one or more surfaces of the one or more mast members 170 (e.g., a mast member web 190, a first mast member flange 192, and/or a second mast member flange 194) within and/or outside of the channel 176 formed therefrom.

As further illustrated in FIGS. 2B-2C and 2H-2I, the mast assembly 110 may further comprise a support drive assembly 210 (otherwise described as a mast drive assembly), a flexible member 230, and/or detachable connectors 250, which allow the one or more dynamic rod supports 160 to move relative to the one or more mast members 170. For example, the support drive assembly 210 may be any type of mechanical, electrical, and/or actuated drive system. However, as illustrated in FIGS. 2B-2C and 2H-2I, in some embodiments the support drive assembly 210 may be a hydraulic drive 212, one or more gears 214, and/or one or more flexible member supports 216 (e.g., gears, sprockets, pullies, or the like), such as upper flexible member supports 217 (e.g., upper gears, or the like) and lower flexible member supports 218. The support drive assembly 210 may further include drive hoses (e.g., not illustrated), which can be connected to a hydraulic system of the moving machinery 10 and/or a separate hydraulic system attached thereto. It should be understood that when two or more mast assemblies 110 are utilized on a rig 100, the two or more mast assemblies 110 may be operated by one or more support drive assemblies 210 (e.g., a single support drive assembly 210 for a single mast assembly 110, a single support drive assembly 210 for multiple mast assemblies 110, and/or multiple support drive assemblies 210 for multiple mast assemblies 110). As will be described in further detail herein, the support drive assembly 210 may automatically disengage in the event the rod 120 reaches an obstruction (e.g., rocks, bedrock, other obstructions, or the like) and is impeded from moving further into the ground. For example, when the pressure within the hydraulic drive 212 moving a rod or the one or more dynamic rod supports 160 becomes too high, a bypass valve may be engaged to prevent the rod 120 or the one or more dynamic rod supports 160 from being driven farther into the ground. While the support drive assembly 210, or components thereof, is illustrated in FIGS. 2G-I as being operatively coupled adjacent the upper portion 112 of the mast assembly 110, it should be understood that the support drive assembly 210, or components thereof, can be located at any location along the mast assembly 110. For example, the support drive assembly 210, or components thereof, may be located near an intermediate portion or a lower portion 114 (as illustrated in FIGS. 2B-2F) of the mast assembly 110.

The flexible member 230 may be any type of flexible member 230, such as a chain, rope, cable, wire, band, belt, or the like) and may extend around the one or more flexible member supports 216, adjacent an upper portion 112 of the mast assembly 110 to adjacent a lower portion 114 of the mast assembly 110. Moreover, the flexible member 230 described herein may be multiple flexible members 230 (e.g., one or more flexible members 230). As such, when discussing a flexible member 230, it should be understood that multiple flexible members 230 may be utilize in the same or similar way as discussed with respect to the flexible member 230. In the illustrated embodiments four flexible members 230 are utilized. The one or more detachable connectors 250 may be operatively coupled to the flexible member 230 and/or one or more of the dynamic rod supports 160 (e.g., to the rod support web 180, or the like). As such, the detachable connectors 250 may be used to allow the dynamic rod supports 160 to move downwardly toward the ground through the movement of the flexible member 230 (e.g., as driven by the support drive assembly 210) until reaching a location at which the dynamic rod supports 160 cannot move downwardly (e.g., when reaching the static rod support 154, or another dynamic rod support 160 that has stopped moving), at which point the detachable connectors 250 disengage the connection between the flexible member 230 and the dynamic rod support 160. Alternatively, when the rod 120 is being retracted, the detachable connectors 250 reengage in order to connect the dynamic rod support 160 and the flexible member 230 to move the dynamic support 160 upwardly (e.g., as driven by the support drive assembly 210) as the rod 120 is being retracted from the ground. The detachable connectors 250 will be described in further detail herein.

As illustrated in FIGS. 2C and 2F-2G, the static rod support 154 may be located at the lower portion 114 of the mast assembly 110, which is used to aid in guiding the rod 120 into the ground. The static rod support 154 may have the same or similar shape and configuration of the dynamic rod supports 160, as previously described herein. Moreover, the static rod support 154 and/or the dynamic rod supports 160 may further comprise a support bracket 186, such as a support bracket 186 that is operatively coupled to the rod support web 180. The support bracket 186 of the one or more rod supports 152 may be used to support and/or guide the rod 120. As such, the rod support bracket 186 may include a rod support aperture 188 that is sized to allow for the receiving rods 120 of different sizes, as illustrated in FIG. 2N. As such, as illustrated in FIG. 2J, different rod guides 126 (e.g., having different sized apertures) may be operatively coupled to the rod support bracket 186 such that different sized rods 120 may extend through the rod support aperture 188. The rod guide 126 may be operatively coupled to the rod support bracket 186 through the use of detachable connectors (e.g., fasteners, such as screws, pins, bolts, or the like, clips, clamps, or other like connectors). The rod guide 126 may include a bushing, such as a low friction polyethylene bushing. However, in other embodiments the rod guide 126 may comprise any component that aids in allowing the rod to move, such as spin within and/or slide through the rod guide 126. For example, the rod guide 126 may comprise one or more bearings (e.g., circular, cylindrical, spherical, rings, or the like) that aid in allowing the rod 120 to rotate and/or pass through the rod guide 126.

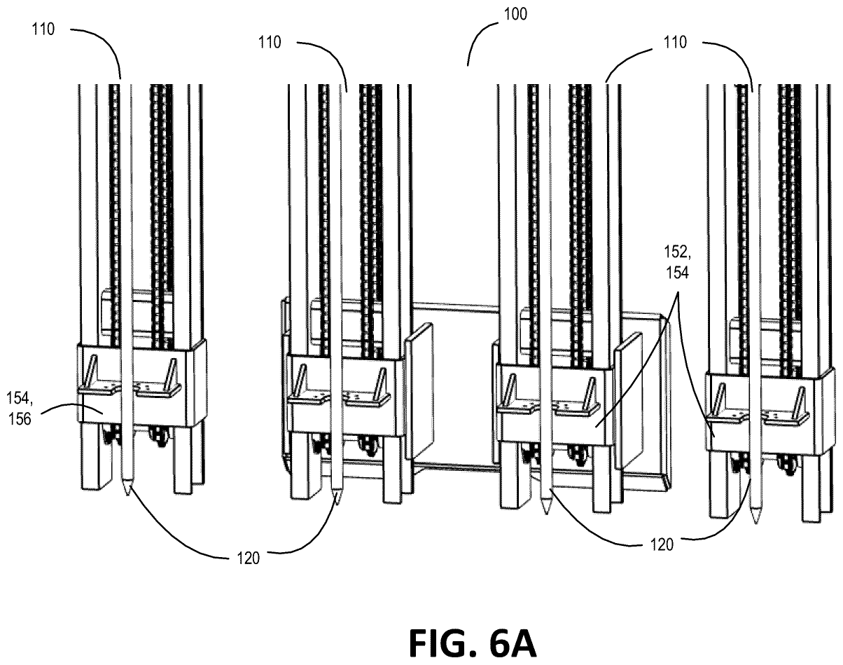

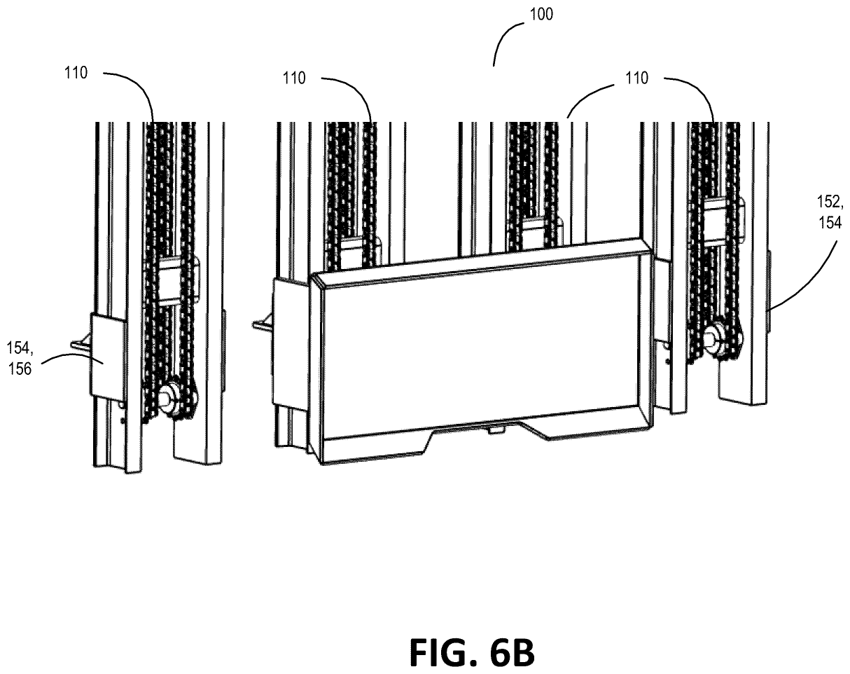

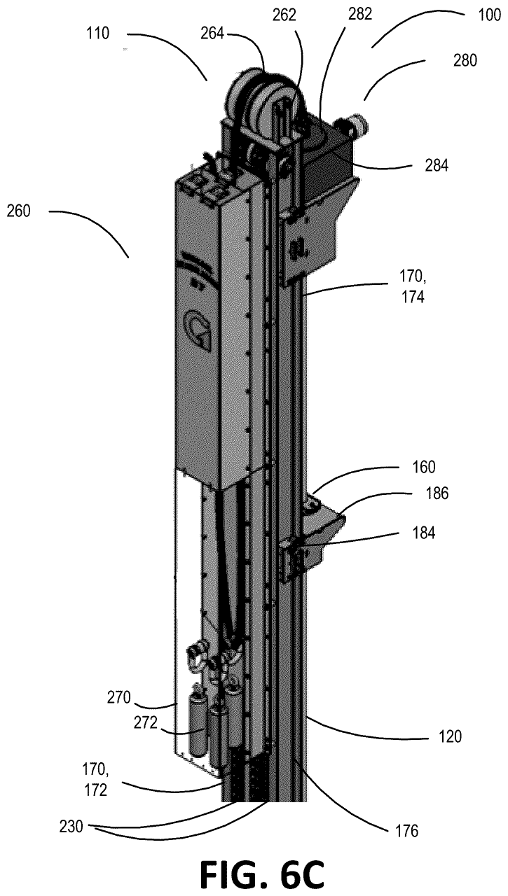

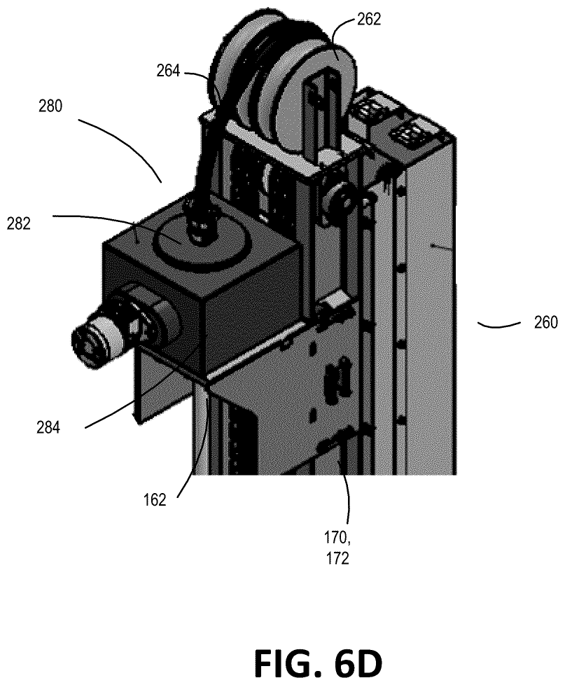

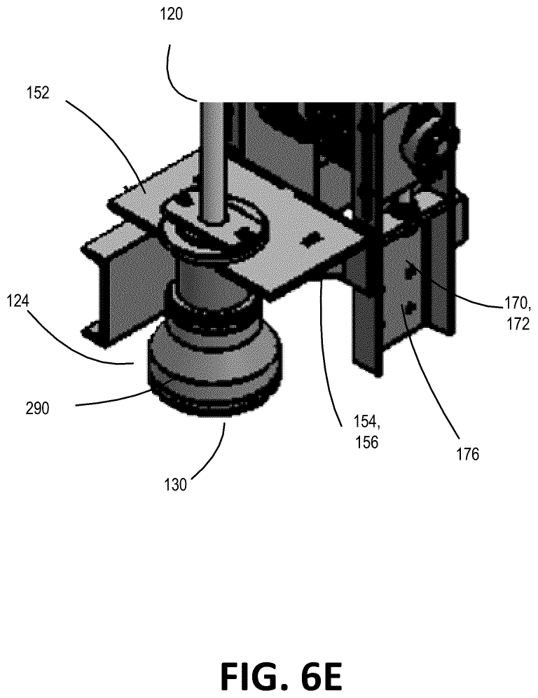

As illustrated in FIG. 6C, the mast assembly 110 may further comprise a fluid supply assembly 260 and/or a rod drive assembly 280. The fluid supply assembly 260 may be utilized to supply the fluid to the rod 120 and then to ground (e.g., for the ground treatment, or the like). The rod drive assembly 280 (otherwise described as a torsional rod drive assembly) may be utilized to provide rotational movement of the rod 120 to aid in extending the rod 120 into the ground.

As further illustrated in FIGS. 2A-2F and 2I-2J, a fluid supply assembly 260 may be operatively coupled adjacent an upper portion 112 of the mast assembly 110. The fluid supply assembly 260 may be utilized to allow a fluid (e.g., liquid, foam, gas, or the like) to be delivered to the rod 120 after or during the insertion of the rod 120 into the ground. The fluid supply assembly 260 may include a fluid hose support 262, a fluid supply hose 264, and a fluid supply 266. The fluid hose support 262 may be any type of support; however, as illustrated in FIGS. 2A-2B and 2I-2J, the hose support 262 may be a static hose support or a dynamic hose support. For example, the static hose support may have one or more channels for supporting a hose 264 and/or allowing the hose 264 to move through the channel. In other examples, the dynamic hose support may be a rotating hose support that is able to rotate in order allow the hose 264 to extend with the rod 120 as the rod 120 is being inserted into the ground and retract as the rod 120 is being removed from the ground. The hose 264 may be allowed to extend or retract through any retractable assembly (e.g., mechanical, electromechanical, pneumatic, hydraulic, or the like). In some embodiments the retractable assembly may include a biasing member 270. The biasing member 270 may be a spring, such as a leaf spring, clock spring, other spring, counterweight, or other biasing member 270 that may at least partially automatically retract the fluid supply hose 264. In particular embodiments, as illustrated in FIG. 6C, the biasing member 270 may comprise one or more counterweights 272 that are used to retract the fluid supply hose 264.

The supply hose 264 may be operatively coupled to the proximal end 122 of the rod 120 in order to deliver a fluid (e.g., liquid, foam, gas, or the like) into the rod 120 for delivery into the ground. The fluid supply 266 may be located in the moving machinery 10, or it may be located on other moveable equipment located adjacent the moving machinery 10. In this way, the fluid may be supplied to the rod 120 in order to treat the ground while still allowing the rod 120 to be extended and/or retracted while the fluid assembly 260 is operatively coupled to the rod 120. While the fluid supply assembly 260, or components thereof, is illustrated as being operatively coupled adjacent the upper portion 112 of the mast assembly 110, it should be understood that the fluid supply assembly 210, or components thereof, can be located at any location along the mast assembly 110. For example, the fluid supply assembly 260, or components thereof, may be located near an intermediate portion or a lower portion 114 of the mast assembly 110.

As illustrated in FIGS. 6C and 6D, the mast assembly 110 may further comprise the rod drive assembly 280. The rod drive assembly 280 (otherwise described as a torsional rod drive assembly, or the like) may be utilized to provide rotational movement of the rod 120 to aid in extending the rod 120 into the ground. The rod drive assembly 280 may comprise a drill drive 282 (e.g., an electric, hydraulic, pneumatic, or the like motor or drive), a gearbox 284, supply lines (e.g., hydraulic fluid supply, power supply, electrical supply, pneumatic supply, or the like). The rod drive assembly 280 may be utilized to rotate the rod 120 (e.g., apply torsional force to the rod 120) in order to aid in extending the rod 120 into the ground (e.g., driving, drilling, or the like). It should be understood that like the fluid supply assembly 260, the rod drive assembly 280 may comprise a supply line support (the same as, or similar to the hose support 262), one or more supply lines, and in some embodiments a fluid supply, or the like that may be needed to operate the drive 282. Moreover, the supply lines may be allowed to extend or retract through any retractable assembly (e.g., the same as, or similar to as previously described with respect to fluid supply assembly 260).

Additionally, or alternatively, in some embodiments, the support drive assembly 210 may further comprise a hammer drive assembly (not illustrated). The hammer drive assembly may be utilized along with, or in place of, the support drive assembly 210 previously discussed herein. The hammer drive assembly may include an anvil (e.g., head of any shape or size) that may be driven (e.g., mechanically, hydraulically, pneumatically, actuation, or the like) in order to aid in driving the rod 120 into the ground. For example, the hammer drive may apply continuous or intermittent pressure against the rod 120 directly (e.g., to an end of the rod) or indirectly (e.g., to the dynamic rod support 160 to which the rod 120 is operatively coupled). That is, the rod 120 may be driven into the ground by pushing the rod 120 or hammering the rod 120 into the ground. It should be understood that any type of drive assembly 210 may be utilized to extend and/or retract the rod 120 into and out of the ground.

As illustrated in FIG. 6E, in some embodiments one or more rod covers 290 may be utilized to restrict (e.g., prevent, reduce, or the like) the fluid that may be delivered into the ground. In some embodiments, the one or more covers 290 may be operatively coupled to the lower static rod support 156, the one or more mast members 170, the rod 120, the rod guide 126, or the like. The one or more rod covers 290 may extend at least partially around the distal rod end 124 of the rod 120 and/or over at least a portion of the rod 120 upstream of the distal rod end 124. Additionally, or alternatively, the one or more rod covers 290 may be configured to extend over the aperture being formed within the ground from the rod 120 to further restrict (e.g., prevent, reduce, or the like) the fluid that may be delivered into the ground from backflowing out of the aperture. In some embodiments, the one or more rod covers 290 may be described as a blowout prevention boot. It should be understood that the one or more rod covers 290 may be made of any material, such as steel, aluminum, other metal, rubber, plastic, composite, or the like material that may be used to restrict the fluid from being distributed. For example, the one or more rod covers 290 may be used to restrict the fluid from being distributed onto the rig 100 (or the components thereof), other equipment in the area, people located in the vicinity, areas around the ground not meant to receive the fluid, structures located in the vicinity, or the like.

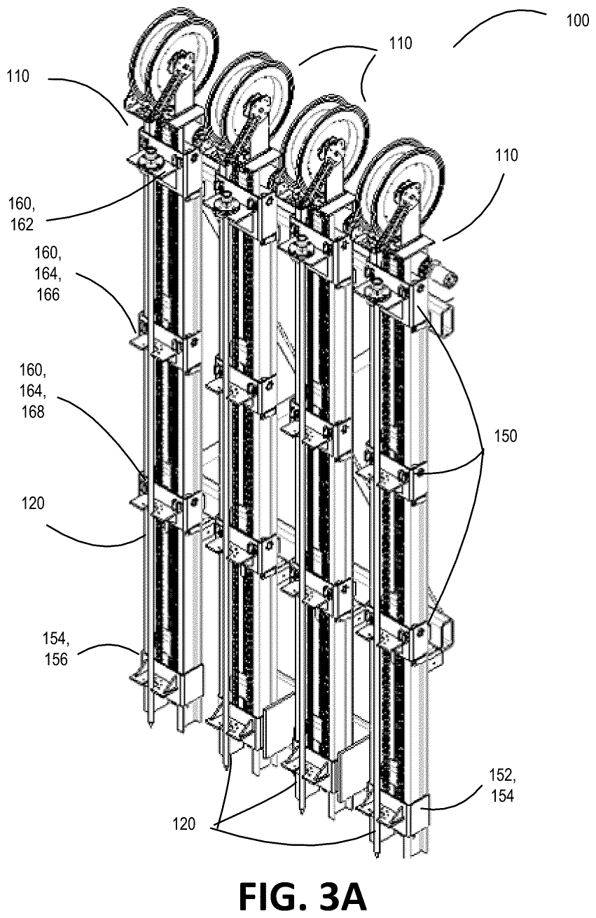

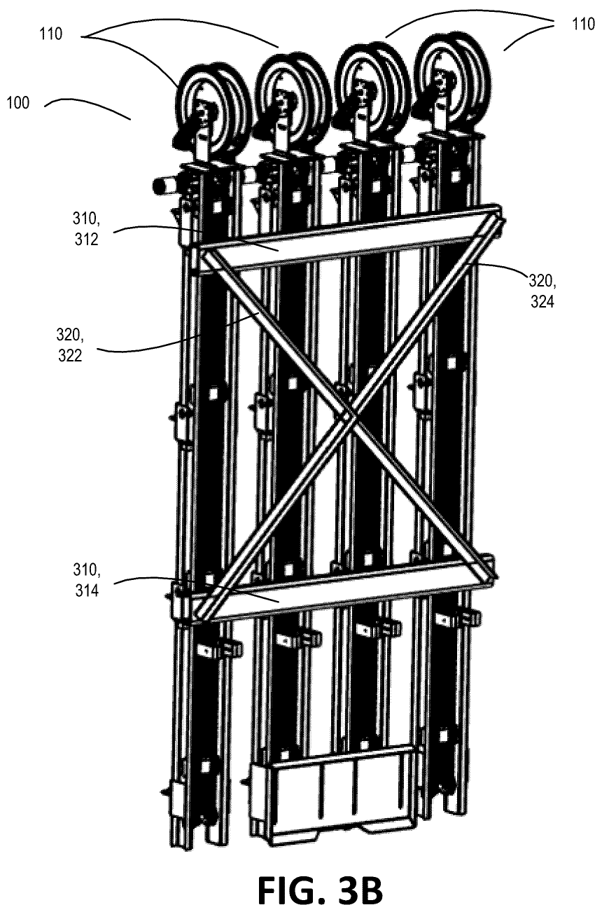

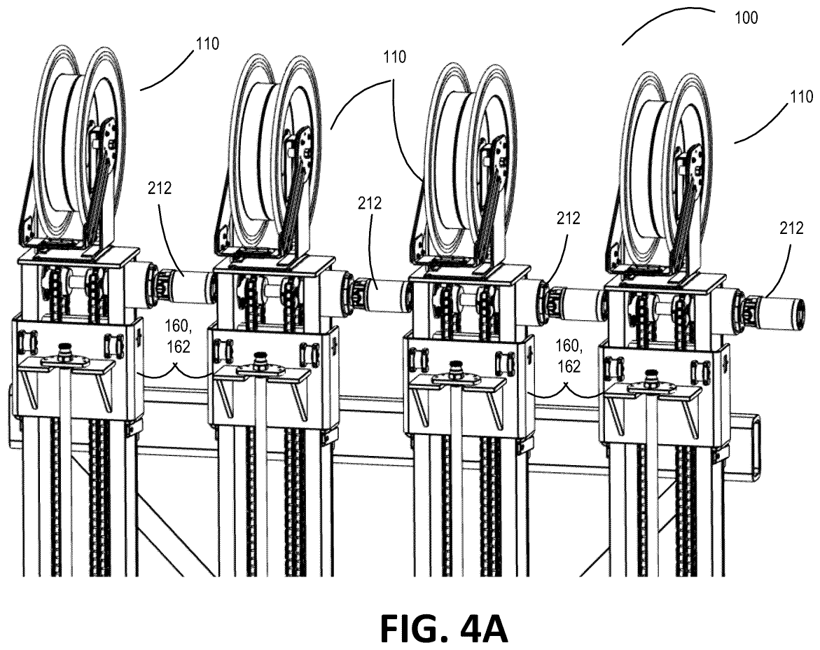

FIGS. 3A through 6B illustrate embodiments in which multiple mast assemblies 110 are utilized within a rig 100. As illustrated in the figures, two or more mast assemblies 110 (e.g., four as illustrated) may be operatively coupled to each other in parallel (e.g., transversely across the width of the machinery 10 when installed). The two or more mast assemblies 110 may be powered by one or more support drive assembles 210 and/or by one or more fluid supply assemblies 260 (e.g., illustrated as each having a drive assembly and a fluid supply assembly). For example, the one or more support drive assemblies 210 of the two or more mast assemblies 110 may be connected in series or in parallel in order to control the extension and/or retraction of the rods 120 of the mast assemblies 110 together using a single system. Alternatively, it should be understood that one or more mast assemblies 110 may have different support drive assemblies 210 in order to independently control the rods 120 of two or more of the mast assemblies 110. For example, each mast assembly 110 may have its own fluid supply assemblies 260, as illustrated in the figures. However, it should be understood that a fluid supply assembly 260, and/or components thereof, may be used for multiple rods 120 and/or multiple mast assemblies 110.

As illustrated in FIG. 3B, the two or more mast assemblies 110 may be operatively coupled through a rig support assembly 300. The rig support assembly 300 may comprise one or more transverse rig supports 310 that are operatively coupled to one or more mast members 170 of the two or more mast assemblies 110. For example, a first transverse rig support 312 and a second transverse rig support 314 may be operatively coupled to one or more mast members 170 of mast assemblies 110 located in parallel with each other. Additionally, in some embodiments, the two or more transverse rig supports 310 may be operatively coupled to each other through the use of rig bracing members 320, such as a first rig cross bracing 322 and a second rig cross bracing 324.

In some embodiments, a rig adjustment assembly (e.g., adjustable rig supports, not illustrated) may be used in order to allow the one or more mast assemblies 110 to be moveable with respect to another mast assembly 110. For example, adjustable rig supports may be extendable and retractable to allow for the plurality of mast assembles 110 to be adjusted transversely with respect to each other (e.g., when located in parallel to increase the transverse distance between the rigs), longitudinally with respect to each other (e.g., when located in series to increase longitudinal distance with respect to each other), and/or may be rotated with respect to each other. For example, the one or more rig supports may be able to swing with respect to each other (e.g., by allowing the rig supports fold) in order to allow one or more of the outer mast assembles 110 to swing with respect to one or more of the intermediate mast assemblies 110 in order to allow the outer mast assembles 110 to fold with respect to the one or more intermediate mast assemblies 110. In other embodiments, the rig adjustment assembly may allow one or more of the outer mast assemblies 110 to be quickly disconnected and/or reconnected to the rig supports. As such, the rig adjustment assembly allows the rig envelope to be reduced for transport (e.g., fit on a truck, rail bed, or the like), and thereafter expended for use in the field.

It should be understood that one or more ground penetrating rigs 100 having one or more mast assemblies 110, each with one or more rods 120, may be used to penetrate the ground at one or more intervals in order to treat the ground. The ground treatment may include, but is not limited to drainage, irrigation, installation of piles, nails, or other ground support members. Moreover, the ground treatment may include breakup of frozen ground, permafrost, minerals, coal, rock, or other materials in the ground. In other applications, the ground treatment may be used to inject fluids (e.g., gel, epoxy, foam, cement, or the like) for sealing, supporting, or raising structures (e.g., buildings, roads, levees, or the like). Other ground treatments may include applying pest control fluids, fertilizer, or the like into the ground. In a particular application, the ground treatment may include providing fluids into the ground for stabilizing the ground. In particular, the ground stabilization may include fluid treatments for restricting (e.g., reducing, preventing, or the like) swelling of clay in soils, such as to reduce potential damage to structures (e.g., buildings, roads, or the like) by improving the ground compressing strength of the soil.

In some embodiments, regardless of the configuration of the ground penetrating rigs 100 and/or one or more mast assemblies 110, and the reason for the ground penetration, the apparatuses 100, 110 may allow the rods 120 to be inserted into the ground a distance of approximately 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, or other like inches apart from each other. In some embodiments, the distance between the rods may range from 24 to 40 inches. However, it should be understood that the distance may range between, overlap, or fall outside any of the foregoing values.

FIGS. 7A through 7C illustrates the operation of a mast assembly 110 of the rig 100. As illustrated in FIG. 7A, the rod 120 is illustrated in the retracted position (otherwise described as the extracted position out of the ground). When the support drive assembly 210 is activated, the one or more dynamic rod supports 160 (e.g., an upper dynamic rod support 162, a first intermediate dynamic rod support 166, a second intermediate dynamic rod support 168, or the like) begin to move and guide the rod 120 as it is being inserted into the ground. The dynamic rod supports 160 continue to move downwardly until the dynamic rod supports 160 are impeded. For example, an intermediate dynamic support 164 (e.g., the second intermediate dynamic rod support 168) may be impeded by a stop, such as the static rod support 154 (e.g., lower static rod support 156), the one or more mast members 170, and/or another stop operatively coupled to the static rod support 154 or one or more mast members 170. When the intermediate dynamic rod support 164 (e.g., the second intermediate dynamic rod support 168) is impeded, the detachable connectors 250 between the flexible member 230 and the intermediate dynamic rod support 164 (e.g., the second intermediate dynamic rod support 168) may allow for disengagement of the flexible member 230 with the intermediate dynamic rod support 164 (e.g., the second intermediate dynamic rod support 168). As such, the flexible member 230 is allowed to continue to move the remaining dynamic rod supports 160, while the disengaged intermediate dynamic rod support 164 (e.g., the second intermediate dynamic rod support 168) remains in place, and allows the rod 120 to move (e.g., slide, or the like) with respect to the disengaged intermediate dynamic rod support 164 (e.g., through the support bracket 186, such as the rod guide 126 thereof).

The support drive assembly 210 continues to move the one or more remaining dynamic rod supports 160 (e.g., an upper dynamic rod support 162, a first intermediate dynamic rod support 166, or the like) to move and guide the rod 120 as it is being inserted into the ground. The dynamic rod supports 160 continue to move downwardly until the next dynamic rod support 160 is impeded. For example, an intermediate dynamic rod support 164 (e.g., the first intermediate dynamic rod support 168) may be impeded by a stop, such as a previous dynamic rod support 160 that has been disengaged (e.g., the second intermediate dynamic rod support 168), the one or more mast members 170, and/or another stop operatively coupled to the previous dynamic rod support 160 and/or one or more mast members 170. When the next intermediate dynamic rod support 164 (e.g., the first intermediate dynamic rod support 166) is impeded, the detachable connectors 250 between the flexible member 230 and the intermediate dynamic rod support 164 (e.g., the first intermediate dynamic rod support 166) may allow for disengagement of the flexible member 230 with the intermediate dynamic rod support 164 (e.g., the first intermediate dynamic rod support 166). As such, the flexible member 230 is allowed to continue to move the remaining dynamic supports 160 (e.g., the upper dynamic rod support 162) while the disengaged intermediate dynamic rod support 164 (e.g., the first intermediate dynamic rod support 166) remains in place and allows the rod 120 to move (e.g., slide, or the like) with respect to the disengaged intermediate dynamic rod support 164 (e.g., the first intermediate dynamic rod support 166) through the support bracket 186, such as the rod guide 126 thereof.

The process repeats until the support drive assembly 210 moves the upper dynamic support 162 into a position in which it is impeded and/or the rod 120 is extended into the ground (e.g., fully, or the like). As such, the upper dynamic support 162 may also become disengaged when it is impeded by a stop, such as the last intermediate dynamic support 164 that has been disengaged (e.g., the first intermediate dynamic rod support 168), the one or more mast members 170, and/or another stop operatively coupled to the last intermediate dynamic support 164 or the one or more mast members 170. In some embodiments, the upper dynamic support 162 may not be disengaged with the flexible member 230 when the rod 120 is fully extended (e.g., inserted into the ground). In this position, as illustrated in FIGS. 7B and 7C, the rod 120 may be fully engaged within the ground. It should be understood that in some embodiments, the configuration of the present invention (e.g., multiple dynamic rod supports 160) may extend 8, 9, 10, 11, 12, 13, 14, 15, 16, 17, 18, 19, 20, or the like feet into the ground. In some embodiments, the depth to which the rods 120 may extend may range from 12 to 18 feet into the ground. However, it should be understood that the distance may range between, overlap, or fall outside any of the foregoing values.

In other embodiments instead of the dynamic supports 160 being impeded adjacent the lower portion 114 of the mast assembly 110, the upper dynamic rod support 162 may move while the intermediate dynamic rod supports 164 remain stationary until the upper dynamic rod support 162 contacts the one or more intermediate dynamic rod supports 164, such as the first intermediate dynamic rod support 166. Thereafter, the upper dynamic support 162 and the first intermediate dynamic rod support 166 both move as the second intermediate dynamic rod support 168 remains stationary until the first intermediate dynamic rod support 166 contacts the second intermediate dynamic rod support 168. Thereafter, the upper dynamic rod support 162 and the one or more intermediate dynamic rod supports 162 (e.g., the first intermediate dynamic rod support 166, the second intermediate dynamic rod support 168, or the like) move until the one or more intermediate dynamic rod supports 162 contact the lower static rod support 156.

As previously discussed herein, should one or more of the rods 120 within the rig 100 be impeded by an obstruction in the ground, the support drive assembly 210 for the rods 120 that are impeded may be disengaged such that damage to the impeded rods 120 may be minimized (e.g., reduced, prevented, or the like). For example, when hydraulics are used, should the pressure being supplied to move a particular rod 120 pass a threshold pressure, a bypass valve may be activated in order to restrict (e.g., reduce, eliminate, or the) additional movement of the impeded rod 120 such that damage to the rod 120 is restricted (e.g., minimized, prevented, or the like). That is, damage (e.g., bending, crushing, shearing, or the like) to the rod 120 may be prevented by stopping the movement of the rod 120. It should be understood that while one or more rods 120 may be stopped from further movement, one or more other rods 120 may continue to be inserted into the ground separately by the one or more support drive assemblies 210.

When the rod 120 is retracted from the ground the opposite processes occurs. That is the flexible member 230 is engaged with the dynamic supports 160 through the detachable connectors 250 as the support drive assembly 210 reverses the movement of the flexible member 230. Each of the dynamic supports 160 move upwardly until they return to their original positions (e.g., ending with the upper dynamic support 162 in some embodiments, all at the same time, or the like).

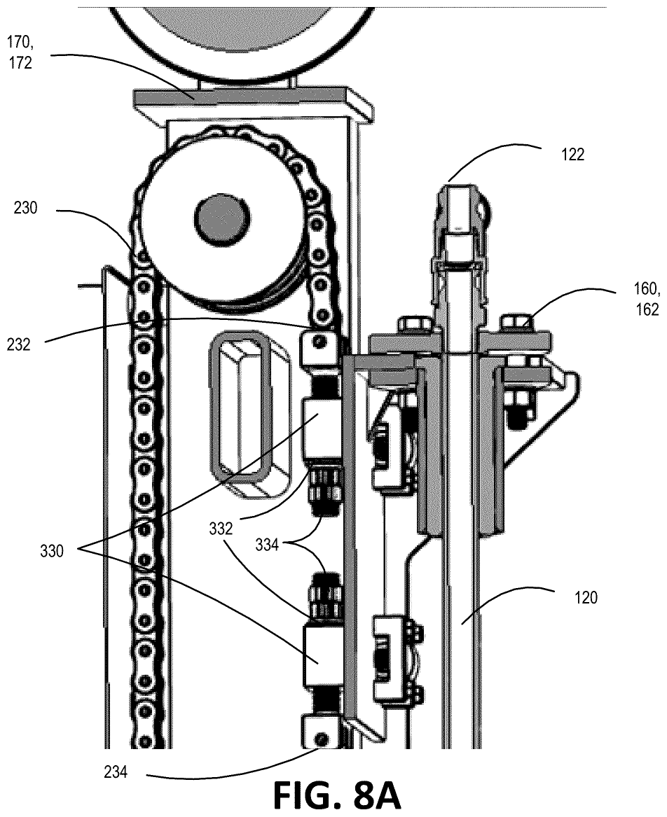

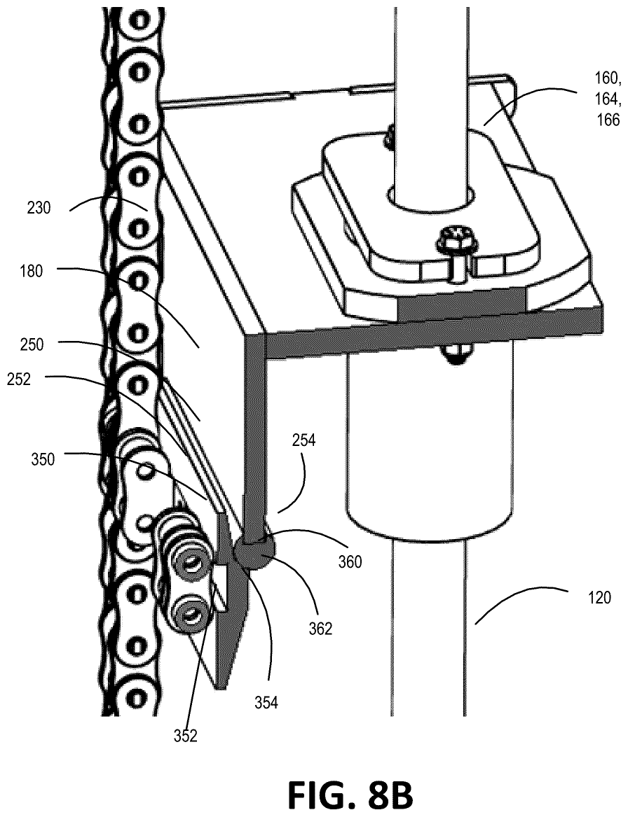

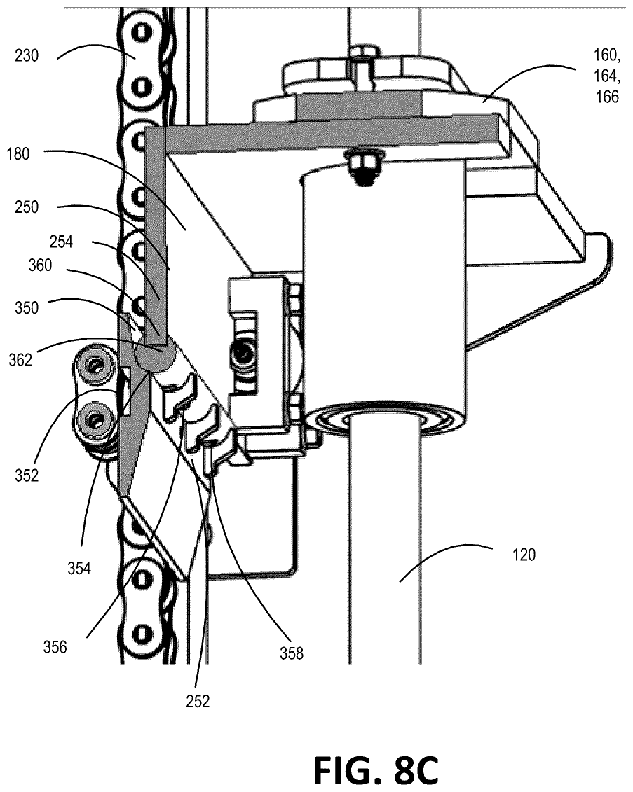

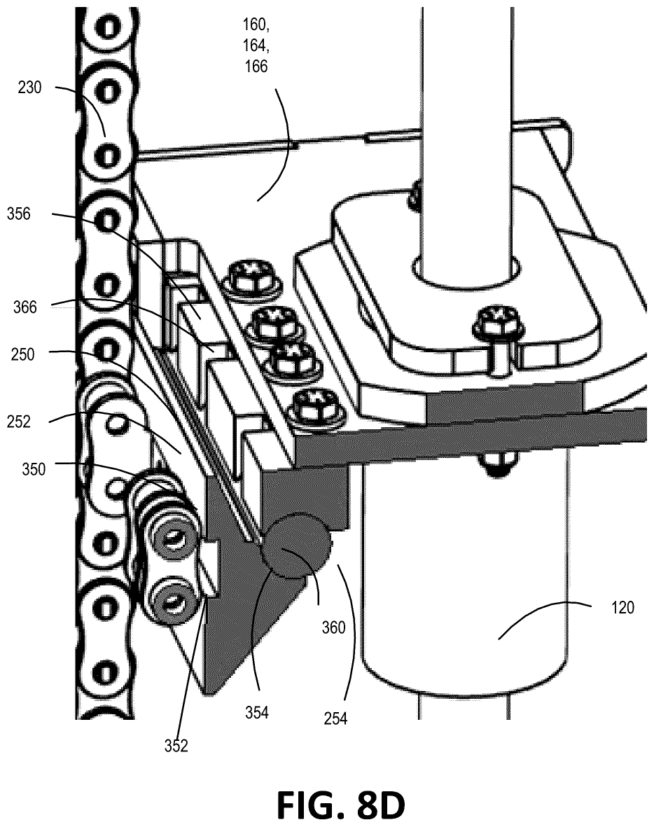

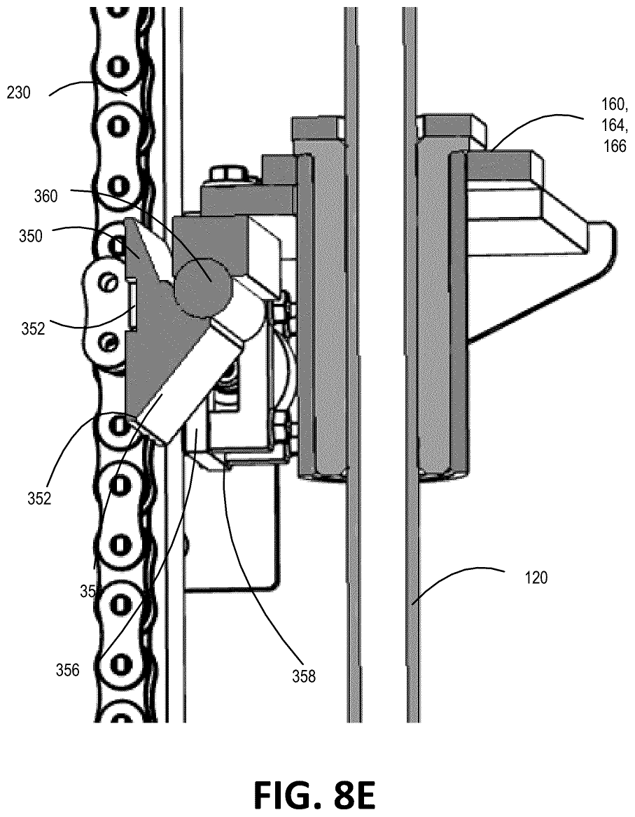

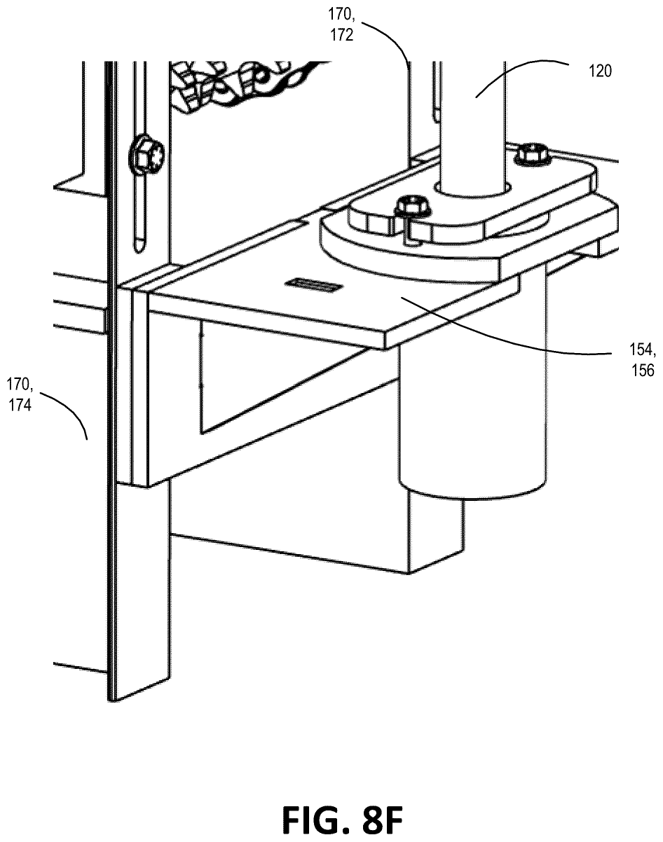

The connections between the dynamic rod supports 160 and the flexible member 230 may be described in further detail with respect to FIGS. 8A through 8F. As illustrated, in FIG. 8A the upper dynamic connector 162 may be operatively coupled to the flexible member 230 through the use of one or more tensioning connectors 330. For example, the one or more tensioning connectors 330 may have one or more tensioning apertures 332 through which one or more tensioning fasteners 334 (e.g., screw, bolts, nuts, pins, dowels, clips, clamps, or the like) may be used to increase or decrease the tension in the flexible member 230. For example, the opposite ends of the flexible member 230 (e.g., a first end 232 and a second end 234) may each comprise a tensioning connector 330 (e.g., coupled through the use of one or more links of a chain, or otherwise coupled to other types of flexible members 230). A user may be able to increase or decrease the tension in the tensioning connector 330 (e.g., loosen or tighten) by moving the one or more tensioning fasteners 334 (e.g., tightening or loosening a bolt, nut, or other type of fastener). The one or more tensioning connectors 330 may be operatively coupled to the upper dynamic rod support 162 in any number of ways. For example, the one or more tensioning connectors 330 may be integral with the upper dynamic rod support 162 (e.g., rod support web 180, or other portion of the rod support). Alternatively, or additionally, the one or more tensioning connectors 330 may be removably operatively coupled to the upper dynamic rod support 162. As such, the one or more tensioning connectors 330 may be used to both allow for adjusting the tension of the flexible member 230 and for coupling the upper dynamic rod support 162 to the flexible member 230. However, it should be understood that the one or more tensioning connectors 330 may be located anywhere between the ends 232, 234 of the flexible member 230. As such, in some embodiments the upper dynamic rod support 162 may be operatively coupled to the flexible member 230 through the use of any type of rod support connectors, such as any type of fastener, clip, clamp, or the like, that may be operatively coupled to any part of the flexible member 230 (e.g., to a link of a chain member, or other type of flexible member)

FIGS. 8B-8E illustrate one embodiment of the detachable connectors 250. While the detachable connectors 250 may comprise any type of detachable connector 250, the detachable connectors 250 may comprise two opposing connectors coupled to the flexible member 230 and a dynamic rod support 160, respectively. For example, the opposing connectors may comprise a receiving connector 252 and a projecting connector 254 that are configured to be removably operatively coupled with each other. That is, the receiving connector 252 (e.g., hook, slot, channel, of any size and shape) may be coupled to the flexible member 230 or the dynamic rod support 160, while the projecting connector 254 (e.g., opposing hook, slot, channel, bar, pin, of any size and shape) may be coupled to the opposite of the flexible member 230 or the dynamic rod support 160. As such, during decoupling of the detachable connector 250, as the rod 120 is being inserted into the ground, the receiving connector 252 and the projecting connector 254 may be uncoupled allowing the flexible member 230 to continue to move while the dynamic rod support 160 remains stationary. Alternatively, during removal of the rod 120 from the ground, the receiving connector 252 and the projecting connector 254 may be coupled to allow the dynamic rod support 160 to move as the flexible member 230 moves.

In the embodiment illustrated in FIGS. 8B-8E, the receiving connector 252 comprises a receiving mount portion 350 having a mount aperture 352 for coupling with the flexible member 230 (e.g., through a key and channel, dovetail, or the like connection). Moreover, the receiving connector 252 may further comprise a receiving channel 354 that is used for operative coupling with the projecting connector 254. As further illustrated in FIGS. 8B-8E the projecting connector 254 may be a projecting mount portion 360 comprising a projection 362 (e.g., solid, hollow, of any circular, oval, square, rectangular, polygonal, uniform, or non-uniform cross-sectional shape, or the like). For example, the projection 362 may be operatively coupled to the rod support web 180 so that is configured to sit within the receiving channel 354 of the receiving mount portion 350.

It should be understood that when multiple intermediate dynamic rod supports 160 are utilized, the detachable connectors 250 may be configured to allow a portion of the detachable connector 250 of a first intermediate dynamic rod support 166 to pass by (e.g., around, though, or the like) a detachable connector 250 of a second intermediate dynamic rod support 168. For example, in some embodiments a first receiving mount portion 350 of a first intermediate dynamic rod support 166 may comprise one or more first fingers 356 that form one or more first finger apertures 358. Moreover, a second projecting mount portion 360 of a second intermediate dynamic rod support 168 may comprise one or more second fingers 366 that form one or more second finger apertures 368. As such, the one or more first fingers 356 will pass through the one or more second fingers apertures 368, as the one or more second fingers 366 pass through the one or more first fingers apertures 358. That is, the one or more first fingers 356 and the one or more second fingers 368 may be offset such that the one or more first fingers 356 pass by the one or more second fingers 368.

In other embodiments, when multiple dynamic rod supports 160 are utilized, the detachable connectors 250 may vary in size and connection locations so that specific receiving connectors 252 and/or projecting connectors 254 will only couple and decouple with each other. In some embodiments, which may not be specifically illustrated in the figures, each successive receiving connector 252 may not extend transversely as far as the next receiving connector 252 (e.g., in a descending order). Alternatively, each successive projecting connector 254 may extend transversely farther than the next projecting connector 254 (e.g., in a descending order). For example, an upper receiving connector 252 may extend transversely farther away from the upper dynamic rod support 160, while an intermediate receiving connector 252 may not extend transversely as far as the upper receiving connector 252. Alternatively, an intermediate projecting connector 254 coupled to the flexible member 230 may extend transversely farther away from an upper projecting connector 254. As such, during coupling as the rod 120 is being removed from the ground, the upper projecting connector 254 passes by the intermediate receiving connector 252 before engaging the upper receiving connector 252. Thereafter, the intermediate projecting connector 254 would be coupled with the intermediate receiving connector 252. Alternatively, during decoupling as the rod 120 is being driven into the ground, in some examples, the upper projecting connector 254 passes by the intermediate receiving connector 252 after it is decoupled from the upper receiving connector.

In other embodiments, the detachable connectors 250 may include rotatable features that allow for the coupling and decoupling of the dynamic rod supports 160 and the flexible members 230 as the rod 120 is being extended into, or withdrawn from the ground.

FIG. 8F illustrates a lower rod support 156 may be operatively coupled to the lower portion of the mast assembly 110, such as a lower portion of the one or more mast members 170 (e.g., the first mast member 172 and/or second mast member 174) by any type of connector (e.g., fastener, such as bolts, nut, pins, dowels, or the fastener, clamp, clip, adhesive, or the like). As previously discussed, the lower rod support 156 may serve as the feature that restricts the second intermediate rod support 168 from moving, and thus, allows the detachable connector 250 to decouple (e.g., allowing the receiving connector 252 to decouple from the projecting connector 254).

While the illustrated embodiments of the invention indicate that the rod 120 is extended to an retracted from the ground using the support drive assembly 210 and detachable connectors 250 discussed herein, it should be understood that another drive (e.g., such as the torsional drive assembly, or the like) may be used to rotate the rod 120 as it is being driven into the ground to aid in penetrating harder surfaces (e.g., bedrock, or the like).

The liquid may distributed through the one or more rods 120 through the use of one or more openings (e.g., apertures) in the rods 12. For example, a single opening in the rod 120 or multiple openings in the rod 120 (e.g., apertures located at the distal rod end 124 of the rod 120 and/or upstream of the distal rod end 124 within the shaft of the rod 120). In some embodiments, the one or more rods 120 may have a nozzle 130. The nozzle 130 of the rod 120 may comprise a pointed tip to aid in driving the rod 120 into the ground. In other embodiments, cutting elements may be located on the nozzle 130 and/or on the rod 120. The cutting elements may comprise of one or more blades, heads, edges, projections, or the like that aid in drilling into the ground or elements withing the ground. Moreover, the nozzle 130 itself may have a plurality of openings (e.g., apertures) located in the nozzle 130 in order to aid in distributing the fluid in multiple directions. In some embodiments, the nozzle 130 may have flow paths and/or rotating components that also aid in distributing the fluid into the ground and/or aiding in the rotation of the rod 120.

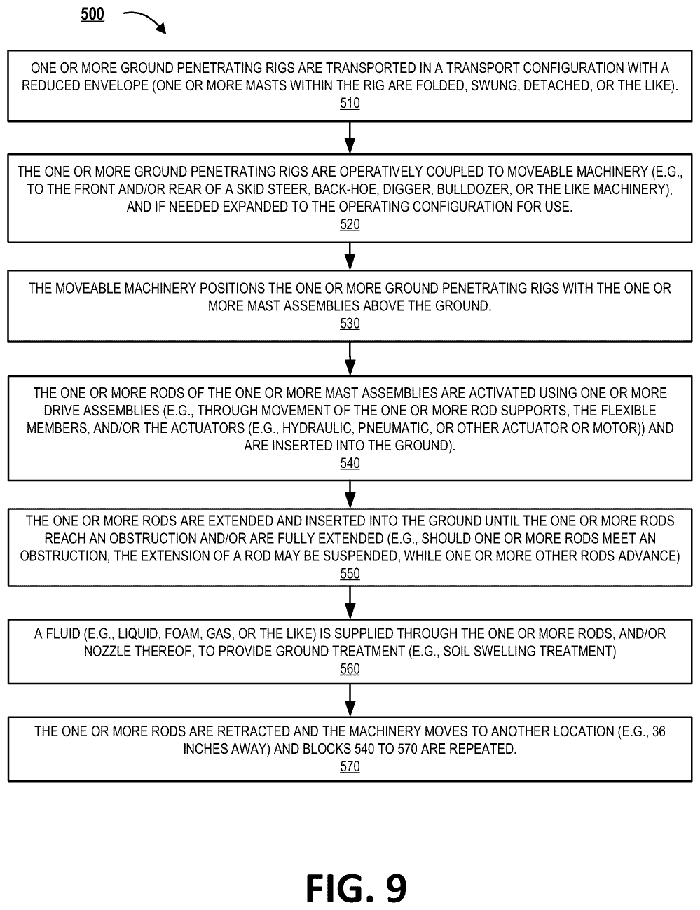

FIG. 9 illustrates embodiments of the invention in which one or more ground penetrating rigs 100 are used to treat the ground. It should be understood that the one or more ground penetrating rigs 100 may be used for any type of ground treatment, as previously discussed herein. However, in particular embodiments, the ground treatment may be specifically for reducing ground swelling of soil, in particular with soil that includes clay.

Regardless of the type of ground treatment, as illustrated by block 510 in FIG. 9, one or more ground penetrating rigs 100 may be transported in a transport configuration with a reduced enveloped (e.g., with one or more mast assemblies 110 folded, swung, detached, or the like). In this way, larger rigs 100 that may be used to treat larger areas of the ground at the same time may be easily transported (e.g., using trucks, railcars, trailers, or the like).

Block 520 of FIG. 9 further illustrates that when on-site, the one or more ground penetrating rigs 100 are operatively coupled to moveable machinery 10, such as to the front and/or rear of a skid steer, as previously discussed herein. However, it should be understood that any type of moveable machinery 10 may be utilized (e.g., back-hoe, bulldozer, or the like machinery). In some embodiments, the one or more mast assemblies 110 may be adjusted into an operating configuration from the transport configuration discussed with respect to block 510. The one or more mast assemblies 110 may be adjusted to the operating configuration before and/or after being assembled to the moveable machinery 10. As previously discussed herein, the adjustment may be performed by moving the one or more mast assemblies 110 with respect to the rig support members 300 (e.g., along the support members, or the like) in order to the space the rods 120 a particular distance from each other. In other embodiments, the one or more mast assemblies 110 may be reassembled to the rig support members 300. In still other embodiments, the one or more outer mast assemblies 110 may be swung and/or unfolded with respect to one or more inner mast assemblies 110 and/or each other.

FIG. 9 further illustrates that once the one or more rigs 100 are operatively coupled to the machinery 10 and/or the one or more mast assemblies 110 are located in the correct orientation, the moveable machinery 10 may position the one or more rigs 100 with the one or more mast assemblies 110 having the one or more rods 120 above the ground to be treated.

Block 540 further illustrates that the one or more rods 120 are extended into the ground by the one or more support drive assemblies 210 and/or the rod drive assembly 280, as previously discussed herein. As previously discussed herein, the one or more support drive assemblies 210 and/or the one or more rod drive assemblies 280 may be any type of drive assemblies. In particular embodiments, hydraulic actuation may be used to move the one or more flexible members 230, which in turn move the dynamic rod supports 160 that drive the rod 120 of each mast assembly 110 into the ground, as previously discussed herein. Additionally, or alternatively, hydraulic actuation may be used to rotate the rod 120 to aid in driving the rod 120 of each mast assembly 110 into the ground, as previously discussed herein.

FIG. 9 further illustrates in block 550 that one or more rods 120 are extended into the ground until the one or more rods 120 are fully extended and/or until one or more rods 120 are impeded by an obstruction in the ground. As previously discussed herein, in the event that the one or more rods 120 are impeded by an obstruction, the further extension of the rod 120 is suspended, while one or more additional rods 120 are advanced until fully extended and/or until reaching an obstruction.

Block 560 of FIG. 9 further illustrates that fluid (e.g., liquid, foam, gas, or the like) may be supplied through the one or more rods 120 and into the ground for the ground treatment through one or more openings in the rod 120 and/or through one or more openings in the nozzle 130 of the rod 120. It should be understood that in some embodiments, the fluid may be applied only after the one or more rods 120 have been extended into the ground. However, in other embodiments, the fluid may be delivered through the one one or more rods 120 and/or the nozzle 130 as the one or more rods 120 are being extended into and/or retracted from the ground.

As illustrated in block 570 of FIG. 9, the one or more rods 120 may be retracted from the ground, as previously discussed herein. After the rods 120 are removed from the ground, the machinery 10 moves to another location (e.g., 36 inches, or the like as described herein) and blocks 540 through 570 of FIG. 9 are repeated. In some embodiments, when both a front rig 100 and a rear rig 100 are utilized, the rods 120 on both the front and rear of the machinery 10 may be used at the same time in order to penetrate the ground at different locations. The machinery 10 may be moved forward until the one or more rods 120 of the rear rig 100 reach the location at which the one or more rods 120 of the front rig 100 were first inserted into the ground (or vice versa). At this point, the machinery 10 may be moved away from the ground treatment location to another location that requires ground treatment, and the process is repeated.

It should be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

Where possible, any terms expressed in the singular form herein are meant to also include the plural form and/or vice versa, unless explicitly stated otherwise. Accordingly, the terms “a” and/or “an” shall mean “one or more.”

Moreover, it should be understood that “operatively coupled” or “coupled,” when used herein, means that the components may be formed integrally with each other, or may be formed separately and coupled together. Furthermore, “operatively coupled” or “coupled” means that the components may be coupled directly to each other, or to each other with one or more components located between the components that are operatively coupled or coupled together. Furthermore, “operatively coupled” or “coupled” may mean that the components are detachable from each other, or that they are permanently coupled together.

Furthermore, certain terminology is used herein for convenience only and is not to be taken as a limiting, unless such terminology is specifically described herein for specific embodiments. Indeed, the components may be oriented in any direction and the terminology, therefore, should be understood as encompassing such variations unless specified otherwise. The terminology includes the words specifically mentioned herein, derivatives thereof and words of similar import. For example, words such as “top”, “bottom”, “upper”, “lower”, “vertical”, “horizontal”, or the like are used to describe the orientation of certain features as illustrated in the Figures. Moreover, it should be understood that when using the terminology “vertical” this could mean exactly perpendicular (e.g., 90 degrees with respect to the ground) or substantially or generally perpendicular (e.g., within +/−5, 10, 15, or the like degrees from 90 degrees with respect to the ground, or the like). Furthermore, it should be understood that when using the terminology “horizonal” this could mean exactly parallel (e.g., 90 degrees with respect to the ground) or substantially or generally parallel (e.g., within +/−5, 10, 15, or the like degrees from 0 degrees with respect to the ground, or the like).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A ground penetrating rig apparatus for treating the ground, the apparatus comprising:
one or more mast assemblies, wherein a mast assembly comprises:
one or more mast members;
one or more rod supports operatively coupled to the one or more mast members; and
a rod operatively coupled to the one or more rod supports;
one or more support drive assemblies operatively coupled to the one or more mast assemblies;
wherein the one or more support drive assemblies are configured to extend the rod of the one or more mast assemblies into the ground and retract the rod from the ground.

2. The apparatus of claim 1, wherein the one or more rod supports comprise:
one or more dynamic rod supports, wherein the one or more support drive assemblies are configured to move the one or more dynamic rod supports to extend the rod into the ground and retract the rod from the ground.

3. The apparatus of claim 2, wherein the one or more dynamic rod supports comprise:
an upper dynamic rod support operatively coupled to a proximal end of the rod; and
one or more intermediate dynamic rod supports;
wherein the upper dynamic rod support moves with the rod; and
wherein the one or more intermediate dynamic rod supports move with the rod and allow the rod to move with respect to the one or more intermediate dynamic rod supports.

4. The apparatus of claim 1, wherein the one or more rod supports comprise:
a static rod support adjacent a distal end of the mast assembly, wherein the static rod support allows the rod to move with respect to the static rod support and guides the rod into the ground.

5. The apparatus of claim 1, wherein the one or more support drive assemblies comprise:
a drive;
a drive train;
one or more flexible members; and
one or more detachable connectors;
wherein the one or more detachable connectors are configured to detach to stop the movement of the one or more dynamic rod supports; and
wherein the one or more detachable connectors are configured to engage to move the one or more dynamic rod supports.

6. The apparatus of claim 5, wherein the drive is a hydraulic drive, and wherein the one or more flexible members comprise one or more chains.

7. The apparatus of claim 1, further comprising:
one or more rod drive assemblies operatively coupled to the one or more mast assemblies;
wherein the one or more rod drive assemblies are configured to rotate the rod to aid in extending the rod into the ground.

8. The apparatus of claim 1, wherein the one or more mast assemblies comprise:
two or more mast assemblies; and
a rig support assembly operatively coupling the two or more mast assemblies;
wherein the one or more support drive assemblies are configured to restrict movement of a first rod of a first mast assembly when the first rod is impeded by an obstruction while continuing to allow a second rod of a second mast assembly to be extended into the ground.

9. The apparatus of claim 8, wherein the one or more support drive assemblies comprise one or more hydraulic drives, and wherein the one or more hydraulic drives are disengaged through a bypass when the first rod is impeded.

10. The apparatus of claim 1, wherein the one or more mast assemblies comprise:
four or more mast assemblies; and
a rig support assembly comprising an adjustment assembly;
wherein the rig support assembly operatively couples the four or more mast assemblies; and
wherein the adjustment assembly is configured to allow adjustment of at least one of the four or more mast assemblies into to a transport configuration that reduces the envelope of the rig apparatus or to adjust the distance between the rods.

11. The apparatus of claim 1, wherein the one or more mast assemblies comprise:
two or more mast assemblies;
a rig support assembly operatively coupling the two or more mast assemblies in a transverse configuration.

12. The apparatus of claim 1, wherein the one or more mast assemblies comprise:
two or more mast assemblies;
a rig support assembly operatively coupling the two or more mast assemblies in a longitudinal configuration.

13. The apparatus of claim 1, further comprising:
a fluid supply system;
wherein the rod is operatively coupled to the fluid supply system configured to supply fluid to the rod and into the ground for ground treatment.

14. The apparatus of claim 13, wherein the fluid supply system comprises:
a supply hose operatively coupled on one end to the rod;
a hose support for supporting the supply hose;
a fluid supply operatively coupled to an opposite end of the supply hose and configured to supply the fluid to the rod for the ground treatment;
wherein the fluid supply system provides the fluid to the rod for the ground treatment; and
wherein the hose support allows for extension of the hose as the rod is extended into the ground and retraction as the rod is removed from the ground.

15. The apparatus of claim 1, further comprising:
a rig support assembly configured for operative coupling with moveable machinery having a hydraulic system, wherein the support drive assembly is powered by the hydraulic system of the moveable machinery.

16. A ground penetrating equipment apparatus for treating the ground, the apparatus comprising:
moveable machinery having a hydraulic system;
one or more ground penetrating rigs operatively coupled to the moveable machinery, wherein a ground penetrating rig comprises:
one or more mast assemblies, wherein a mast assembly comprises:
one or more mast members;
one or more rod supports operatively coupled to the one or more mast members; and
a rod operatively coupled to the one or more rod supports;
one or more support drive assemblies operatively coupled to the one or more mast assemblies and to the hydraulic system of the moveable machinery;
wherein the one or more support drive assemblies are configured to extend the rod into the ground and retract the rod from the ground.

17. The apparatus of claim 16, wherein the one or more mast assemblies of the ground penetrating rig comprises:
two or more mast assemblies; and
a rig support assembly operatively coupling the two or more mast assemblies;
wherein the one or more support drive assemblies are configured to restrict movement of a first rod of a first mast assembly when the first rod is impeded by an obstruction while continuing to allow a second rod of a second mast assembly to be extended into the ground.

18. The apparatus of claim 16, wherein the one or more ground penetrating rigs comprise:
a first ground penetrating rig operatively coupled to a front of the moveable machinery; and
a second ground penetrating rig operatively coupled to a rear of the moveable machinery.

19. A method of treating the ground using a ground penetrating equipment apparatus, wherein the ground penetrating equipment apparatus comprises:
moveable machinery comprising a hydraulic system;
one or more ground penetrating rigs operatively coupled to the moveable machinery, a ground penetrating rig comprising:
one or more mast assemblies, wherein a mast assembly comprises:
one or more mast members;
one or more rod supports operatively coupled to the one or more mast members; and
a rod operatively coupled to the one or more rod supports;
one or more support drive assemblies operatively coupled to the one or more mast assemblies and to the hydraulic system of the moveable machinery; and
wherein the method comprises:
extending the rod of the one or more mast assemblies into the ground; and
treating the ground with fluid through the rod of the one or more mast assemblies.

20. The method of claim 19, wherein the one or more mast assemblies comprise two or more mast assemblies and a rig support assembly operatively coupling the two or more mast assemblies, wherein the method further comprises:
restricting movement of a first rod of a first mast assembly when the first rod is impeded by an obstruction;
continuing to allow a second rod of a second mast assembly to be extended into the ground while the movement of the first rod of the first mast assembly is restricted.
